(19) United States
(12) Patent Application Publication
(10) Pub. No.: US 2024/0084150 A1
(43) Pub. Date: Mar. 14, 2024

(54) THERMALLY STABILISED CONDUCTIVE POLYMER COATINGS

(71) Applicants: THE BOEING COMPANY, Chicago, IL (US); Commonwealth Scientific and Industrial Research Organisation, Acton, ACT (AU)

(72) Inventors: Patrick J. KINLEN, Fenton, MO (US); Eric Alan BRUTON, Lake St. Louis, MO (US); Thomas Matthew KOHL, Acton, ACT (AU); Maria ESPIRITU, Acton, ACT (AU)

(21) Appl. No.: 18/258,619

(22) PCT Filed: Dec. 21, 2021
(86) PCT No.: PCT/AU2021/051531

§ 371 Date: Jun. 21, 2023

Related U.S. Application Data
(60) Provisional application No. 63/128,660, filed on Dec. 21, 2020.

(51) Int. Cl. C09D 5/24; C09D 5/18; C09D 7/20; C09D 7/40; C09D 7/48; C09D 7/62; C09D 7/63; C09D 179/02; H01B 1/12

(52) U.S. Cl. CPC C09D 5/24; C09D 5/18; C09D 7/20; C09D 7/48; C09D 7/62; C09D 7/63; C09D 7/69; C09D 179/02; H01B 1/128

(57) ABSTRACT

The present disclosure generally relates to coatings and compositions comprising conductive polymers. The present disclosure also relates to thermally stable coatings and compositions comprising solution processable polyaniline conducting polymers and thermal stability agents, and to processes for preparing the coatings and compositions.

### FIELD

The present disclosure generally relates to coatings and compositions comprising conducting polymers. The present disclosure also relates to thermally stabilised coatings and compositions comprising solution processable conducting polymers, and to processes for preparing the coatings and compositions.

### BACKGROUND

Conducting polymers, such as polyaniline, have attracted considerable attention in recent years as materials for various applications, including antistatic coatings and corrosion protection among other potential uses. There is currently a demand for conductive polymer coatings with improved performance in various applications, such as conductive polymer coatings having higher thermal stability.

In one example, non-conducting polyaniline emeraldine base (i.e. undoped) is thermally stable up to around 450° C., although thermal stability in conducting forms of polyaniline (i.e. doped) is significantly lower. Existing technologies that might address the thermal stability of conductive polymers are limited and in some examples involve modification of dopants including self-doping of polymers. The difficulty with changing the dopant is that the conducting polymer may no longer form a processable solution. This significantly limits the applications of the technology.

In order to obtain the physical and/or electronic improvements in polyaniline conducting polymers brought through the use of dopants, and retain conductivity for at least a period of time at elevated temperatures, then there is a need to provide new and alternative polyaniline conducting polymer compositions, coatings, and processes thereof.

Any discussion of documents, acts, materials, devices, articles or the like which has been included in the present specification is solely for the purpose of providing a context for the present disclosure. It is not to be taken as an admission that any or all of these matters form part of the prior art base or were common general knowledge in the field relevant to the present disclosure as it existed before the priority date of each claim of this application.

### SUMMARY

The present disclosure provides particular agents that are compatible with coating compositions comprising polyaniline conducting polymers for improving thermal stability of coatings. The present disclosure also provides compositions comprising polyaniline conducting polymers and thermal stability agents that are readily processable for preparation of coatings on various substrates.

In one aspect, there is provided a composition comprising a solution processable polyaniline conducting polymer and one or more thermal stability agents selected from an alkali metal salt, an amphoteric metal oxide, an antioxidant, or any combinations thereof.

In another aspect, there is provided a composition consisting of a solution processable polyaniline conducting polymer and one or more thermal stability agents selected from an alkali metal salt, an amphoteric metal oxide, an antioxidant, or any combinations thereof, optionally a film former, and optionally one or more additives.

In another aspect, there is provided a liquid formulation comprising: a solution processable polyaniline conducting polymer in an organic solvent, one or more first thermal stability agents selected from an alkali metal salt, and optionally an amphoteric metal oxide, and one or more of second thermal stability agents selected from an antioxidant, wherein the combined amount of the one or more first thermal stability agents (as a weight % of total formulation) is about 2 wt % to about 7 wt %, wherein the total amount of the first and second thermal stability agents (as a weight % of total formulation) is less than about 9 wt %, wherein the first and second thermal stability agents are present in the organic solvent, and wherein the polyaniline conducting polymer solution has greater than 95% of a polyaniline salt dissolved in the organic solvent.

In another aspect, there is provided a liquid formulation consisting of: a solution processable polyaniline conducting polymer in an organic solvent, one or more first thermal stability agents selected from an alkali metal salt, and optionally an amphoteric metal oxide, one or more second thermal stability agents selected from an antioxidant, and one or more film formers, wherein the combined amount of the one or more first thermal stability agents (as a weight % of total formulation) is about 2 wt % to about 7 wt %, wherein the total amount of the first and second thermal stability agent (as a weight 30% of total formulation) is less than about 9 wt %, wherein the first and second thermal stability agents are present in the organic solvent, and wherein the polyaniline conducting polymer solution has greater than 95% of a polyaniline salt dissolved in the organic solvent.

In another aspect, there is provided a process for preparing a liquid formulation, comprising the steps of: mixing (i) one or more first thermal stability agents selected from an alkali metal salt, and optionally an amphoteric metal oxide and (ii) one or more second thermal stability agents selected for an antioxidant with (ii) a solution processable polyaniline conducting polymer that is dissolved in an organic solvent, wherein the polyaniline conducting polymer is an organic solvent soluble polyaniline conducting polymer salt made in-situ by polymerising an aniline monomer with a protonic acid in the organic solvent, wherein the combined amount of the one or more first thermal stability agents (as a weight % of total formulation) is about 2 wt % to about 7 wt %, wherein the total amount of the first and second thermal stability agent (as a weight % of total formulation) is less than about 9 wt %, and wherein the polyaniline conducting polymer solution has greater than 95% of a polyaniline salt dissolved in the organic solvent.

In another aspect, there is provided a substrate comprising one or more coating layers, wherein at least one of the coating layers comprises a formulation according to any aspects, aspects or examples thereof as described herein.

In another aspect, there is provided a coating applied to an optionally coated substrate, wherein the coating comprises a formulation according to any aspects, aspects or examples thereof as described herein.

In another aspect, there is provided a coating system comprising:
(i) an optionally coated substrate;
(ii) one or more optional post coating layers; and
(iii) one or more layers located between (i) and (ii) comprising a formulation according to any aspects, embodiments or examples thereof as described herein.

In an embodiment, the polyaniline conducting polymer coating of the above method or use can be provided by a coating composition according to any aspects, embodiments or examples thereof as described herein.

Any aspect herein shall be taken to apply mutatis mutandis to any other aspect unless specifically stated otherwise.

The present disclosure is not to be limited in scope by the specific aspects described herein, which are intended for the purpose of exemplification only. Functionally-equivalent products, compositions and methods are clearly within the scope of the disclosure, as described herein.

Throughout this specification, unless specifically stated otherwise or the context requires otherwise, reference to a single step, composition of matter, group of steps or group of compositions of matter shall be taken to encompass one and a plurality (i.e. one or more) of those steps, compositions of matter, groups of steps or groups of compositions of matter.

### BRIEF DESCRIPTION OF THE DRAWINGS

Preferred aspects of the present disclosure will be further described and illustrated, by way of example only, with reference to the accompanying drawings in which:

FIG. 1 is a schematic of the continuous flow process for preparing a conducting polymer according to one example of the present disclosure;

FIG. 2 is a flow diagram showing a process for preparing a thermally stabilised conducting polymer coating according to one example of the present disclosure;

FIG. 3 shows photographic images of thin films formed from conducting polymer coatings comprising thermal stability agents according to some examples of the present disclosure;

FIG. 4 provides resistance measurements of PANI films containing thermal stability agents according to some examples of the present disclosure collected by multi-meter over time during heating at 150° C.;

FIG. 5 provides TGA data according to some examples of the present disclosure;

FIG. 6 provides representative TGA-MS curve showing thermal desulfonation of DNNSA (m/z 64, 48 and 80) according to an example of the present disclosure;

FIG. 7 is a TGA-MS curve for S3 (m/z 18).

FIG. 8 provides conductivity data for PANI-DNNSA films containing O2T heated under air and N₂ atmospheres according to an example of the present disclosure;

FIG. 9 shows effect of cure atmosphere and heating atmosphere on subsequent film thermal stability according to some examples of the present disclosure.

FIG. 10 provides a data summary based on failure time (confirmed with multi-meter) according to some examples of the present disclosure;

FIG. 11 provides variation in PANI thin film failure time under heating with ZnO concentration according to an example of the present disclosure;

FIG. 12 provides a graph showing continuous logging of film resistance for samples containing different amounts of silicone dispersion (R-1009) comprising thermal stability agents according to some examples of the present disclosure.

### DETAILED DESCRIPTION

The present disclosure describes the following various non-limiting examples, which relate to investigations undertaken to identify alternative and improved polyaniline conducting polymer compositions, and to any formulations, coatings, and methods of making and use thereof.

### General Definitions and Terms

In the following description, reference is made to the accompanying drawings which form a part hereof, and which is shown, by way of illustration, several aspects. It is understood that other aspects may be utilised and structural changes may be made without departing from the scope of the present disclosure.

With regards to the definitions provided herein, unless stated otherwise, or implicit from context, the defined terms and phrases include the provided meanings. In addition, unless explicitly stated otherwise, or apparent from context, the terms and phrases below do not exclude the meaning that the term or phrase has acquired by a person skilled in the relevant art. The definitions are provided to aid in describing particular aspects, and are not intended to limit the claims. Furthermore, unless otherwise required by context, singular terms shall include pluralities and plural terms shall include the singular.

All publications discussed and/or referenced herein are incorporated herein in their entirety.

Throughout this disclosure, unless specifically stated otherwise or the context requires otherwise, reference to a single step, composition of matter, group of steps or group of compositions of matter shall be taken to encompass one and a plurality (i.e., one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

Those skilled in the art will appreciate that the disclosure herein is susceptible to variations and modifications other than those specifically described. It is to be understood that the disclosure includes all such variations and modifications. The disclosure also includes all of the examples, steps, features, methods, compositions, coatings, processes, and coated substrates, referred to or indicated in this specification, individually or collectively, and any and all combinations or any two or more of said steps or features.

The term “and/or”, e.g., “X and/or Y” shall be understood to mean either “X and Y” or “X or Y” and shall be taken to provide explicit support for both meanings or for either meaning.

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of lower-numbered item (e.g., a “first” item) and/or a higher-numbered item (e.g., a “third” item).

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example and without limitation, two of item A, one of item B, and ten of item C; four of item B and seven of item C; or some other suitable combination.

It is to be appreciated that certain features that are, for clarity, described herein in the context of separate aspects, may also be provided in combination in a single aspect. Conversely, various features that are, for brevity, described in the context of a single aspect, may also be provided separately or in any sub-combination.

Throughout the present specification, various aspects and components of the present disclosure can be presented in a range format. The range format is included for convenience and should not be interpreted as an inflexible limitation on the scope of the present disclosure. Accordingly, the description of a range should be considered to have specifically disclosed all the possible sub-ranges as well as individual numerical values within that range, unless specifically indicated. For example, description of a range such as from 1 to 5 should be considered to have specifically disclosed sub-ranges such as from 1 to 3, from 1 to 4, from 1 to 5, from 2 to 4, from 2 to 5, from 3 to 5 etc., as well as individual and partial numbers within the recited range, for example, 1, 2, 3, 4, 5, 5.5 and 6, unless where integers are required or implicit from context. This applies regardless of the breadth of the disclosed range. Where specific values are required, these will be indicated in the specification.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Throughout this specification, the term “consisting essentially of” is intended to exclude elements which would materially affect the properties of the claimed composition.

The terms “comprising”, “comprise” and “comprises” herein are intended to be optionally substitutable with the terms “consisting essentially of”, “consist essentially of”, “consists essentially of”, “consisting of”, “consist of” and “consists of”, respectively, in every instance.

Herein the term “about” encompasses a 10% tolerance in any value or values connected to the term.

As used herein “curable” or “cured” is descriptive of a material or composition that has or can be cured (e.g., polymerised or crosslinked) by heating to induce polymerisation and/or crosslinking; irradiating with actinic irradiation to induce polymerisation and/or crosslinking; and/or by mixing one or more components to induce polymerisation and/or crosslinking. “Mixing can be performed, for example, by combining two or more parts and mixing to form a homogeneous composition. Alternatively, two or more parts can be provided as separate layers that intermix (e.g., spontaneously or upon application of shear stress) at the interface to initiate polymerization.

Reference to “substantially free” generally refers to the absence of that compound or component in the composition other than any trace amounts or impurities that may be present, for example this may be an amount by weight % in the total composition of less than about 1%, 0.1%, 0.01%, 0.001%, or 0.0001%. The compositions as described herein may also include, for example, impurities in an amount by wt % in total composition of less than about 2%, 1%, 0.5%, 0.1%, 0.01%, or 0.001%, or 0.0001%.

Herein “weight %” may be abbreviated to as “wt %”.

### Conducting Polymer Compositions

The present disclosure is directed to providing improvements in conductive coatings including improved stability, particularly at elevated temperatures. The present disclosure covers various research and development directed to identifying agents that are compatible with coating compositions comprising polyaniline conducting polymers that also provide excellent thermal stability to the coatings. Investigations also involved developing compositions that were readily processable for preparing effective coatings on various substrates, for example solution processable antistatic coatings for use on electronic circuit boards.

The thermal stability agents, at least according to some examples as described herein, can also provide effective compatibility for use with solution processable coating compositions comprising a polyaniline conducting polymer. The thermal stability agents, at least according to some examples as described herein, can also inhibit processes causing degradation of the polyaniline conducting polymers present in the coatings, particularly when the coatings are present in environments at elevated temperatures.

It has also been found that the addition of one or more thermal stability agents to coatings or compositions comprising one or more polyaniline conducting polymers, at least according to some examples as described herein, may be used to:
(a) restrict or reduce detrimental degradation and/or loss of a dopant; and/or
(b) limit the oxidation of the polymer chain in the conducting polymer.

For example, with regard to polyaniline sulphonate salts (e.g. PANI-DNNSA), it has been found that the introduction of one or more thermal stability agents as described herein, can inhibit, restrict or reduce:
(i) desulfonation of the sulphonate salt (e.g. DNNSA dopant); and/or
(ii) oxidation of the PANI polymer chain.

For example, with regard to polyaniline sulphonate salts (e.g. PANI-DNNSA), it has been found that the introduction of one or more first thermal stability agents selected from an alkali metal salt, and optionally an amphoteric metal oxide, and one or more of second thermal stability agents selected from an antioxidant as described herein, can inhibit, restrict or reduce:
(i) desulfonation of the sulphonate salt (e.g. DNNSA dopant); and/or
(ii) oxidation of the PANI polymer chain.

It has also been found that one or more thermal stability agents according to at least some examples as described herein can be used in a coating comprising one or more solution processable polyaniline conducting polymers and optionally one or more film formers (e.g., PANI-DNNSA in a silicone dispersion), to form a readily processable coating having excellent thermal stability and desirable mechanical properties.

According to at least some aspects or examples of the thermal stability agents, and compositions and coatings thereof, as described herein, thermal stability can be provided such that at a temperature of about 150° C. the electrical resistance of the compositions or coatings comprising the one or more conducting polymers (e.g. a PANI sulphonate salt) remains below about 100 MΩ over at least 1 week. The thermal stability may be provided in an environment of air, vacuum or inert atmosphere (e.g. nitrogen). The compositions and coatings, at least according to some aspects or examples thereof as described herein, can also be stable at or below about 150° C.

In one aspect, embodiment or example, there is provided a composition comprising a solution processable polyaniline conducting polymer in an organic solvent and one or more thermal stability agents selected from an alkali metal salt, an amphoteric metal oxide, an antioxidant, or any combinations thereof.

In another aspect, embodiment or example, there is provided a composition consisting of a solution processable polyaniline conducting polymer in an organic solvent and one or more thermal stability agents selected from an alkali metal salt, an amphoteric metal oxide, an antioxidant, or any combinations thereof, optionally a film former, and optionally one or more additives.

The composition is a liquid composition (e.g. liquid formulation) or a dry film coating. In one example the composition is a liquid composition.

In another aspect, embodiment or example, there is provided a liquid formulation comprising a solution processable polyaniline conducting polymer in an organic solvent, one or more first thermal stability agents selected from an alkali metal salt, and optionally an amphoteric metal oxide, and one or more of second thermal stability agents selected from an antioxidant, wherein the combined amount of the one or more first thermal stability agents (as a weight % of total formulation) is about 2 wt % to 7 wt %, wherein the total amount of the first and second thermal stability agents (as a weight % of total formulation) is less than about 9 wt %, wherein the first and second thermal stability agents are present in the organic solvent, and wherein the polyaniline conducting polymer solution has greater than 95% of a polyaniline salt dissolved in the organic solvent.

The liquid formulation may further comprise one or more film formers.

In another aspect, embodiment or example, there is provided a liquid formulation consisting of a solution processable polyaniline conducting polymer in an organic solvent, one or more first thermal stability agents selected from an alkali metal salt, and optionally an amphoteric metal oxide, one or more second thermal stability agents selected from an antioxidant, and one or more film formers, wherein the combined amount of the one or more first thermal stability agents (as a weight % of total formulation) is about 2 wt % to 7 wt %, wherein the total amount of the first and second thermal stability agent (as a weight % of total formulation) is less than about 9 wt %, wherein the first and second thermal stability agents are present in the organic solvent, and wherein the polyaniline conducting polymer solution has greater than 95% of a polyaniline salt dissolved in the organic solvent. The polyaniline salt remains dissolved in the organic solvent even after addition of the thermal stability agents.

### Conductive Compositions and Coatings

Electrically conductive coatings traditionally rely on solid conductive fillers such as silver or carbon black which requires percolation of the solids or enough of the volume of the coating to be taken up with the filler so that the conductive particles are touching to allow for electrons to flow across the coating. If percolation is not reached then the resin, often an insulator or dielectric, occupies the space between the conductive particles, and electrons will not flow across the coatings. For spherical particles this volume of the coating would need to be >28%. Solid forms of conductive polymers would also need to meet the criteria to make a conductive coating. With a soluble conductive polymer dispersed in a resin system of a coating where the conductive polymer is soluble, (as opposed to coiled up, discreet balls of polymer) the resulting solution allows for much lower volume of conductive material to reach percolation with an extremely high aspect ratio.

It is known from the prior art that the aniline monomer can be polymerised to polyaniline (PANI) and then dissolved in a water/alcohol solvent system to create a conductive salt prior to addition of various additives. It will be appreciated that to achieve a uniform particle size during dissolution of PANI is very difficult. A significant portion of PANI will form agglomerates (i.e. coiled up in discreet balls of polymer) resulting in reduced conductivity. As such, the resultant PANI-DNNSA solution will have a mixture of PANI-DNNSA and undissolved PANI agglomerates. Inclusion of additives into such a solution in turn results in even larger agglomerates and/or a dispersion that is not uniform. This type of processes are industrially unreliable, especially for during formation of conducting films/coatings. Furthermore, it also becomes difficult to predict the amounts of additives that would be required without significant trial and error.

The inventors have advantageously found that PANI-DNNSA, formed in-situ by polymerising aniline with a dopant in an organic solvent provides a highly conducting PANI-DNNSA solution. It has unexpectedly been found that the higher conductivity is as a result of even distribution and better dissolution of the polymer salt in the organic solvent. In some embodiments or examples, the polyaniline conducting polymer solution has greater than 95% of a polyaniline salt dissolved in the organic solvent. In other words, greater than 95 wt % PANI-DNNSA is dissolved in organic solvent and is not present as particles or agglomerates, or coiled up in discreet balls of polymer.

It will be appreciated that at least one of the disadvantages of pre-formed PANI-DNNSA salt, i.e., that is first formed and later dissolved in an organic solvent system, is that excess salt (e.g., DNNSA) can react with the polymer backbone and lead to thermal instability. The inventors have surprisingly found a composition and process to prepare a thermally stable PANI-DNNSA solution without the need to first isolate the polymer (e.g., PANI) or the polymer salt (e.g., PANI-DNNSA), wherein the polyaniline conducting polymer solution has greater than 95% of a polyaniline salt dissolved in the organic solvent.

### Thermal Stability Agents

The thermal stability agents can be selected from an alkali metal salt, an amphoteric metal oxide, an antioxidant, or any combinations thereof. The inventors have found that the introduction of one or more first thermal stability agents selected from an alkali metal salt, and optionally an amphoteric metal oxide, and one or more of second thermal stability agents selected from an antioxidant as described herein, can inhibit, restrict or reduce: desulfonation of the sulphonate salt (e.g. DNNSA dopant); and/or oxidation of the PANI polymer chain, as well as inhibit, restrict or reduce the precipitation of the polyaniline conducting polymer from the organic solvent for which it is dissolved. One or more advantages of the present disclosure according to at least some embodiments or examples as described herein is that the polyaniline conducting polymer is dissolved in an organic solvent and remains dissolved in the organic solvent, even after the addition of one or more thermal stability agents, optional film formers, and optional dispersants and/or additives.

In one example, the composition comprises a thermal stability agent selected from at least one antioxidant, at least one alkali metal salt, and at least one amphoteric metal oxide. In another example, the composition comprises at least one alkali metal salt and at least one antioxidant. In another example, the composition comprises at least one alkali metal salt.

In one example, one or more of the thermal stability agents is present in the compositions in an amount (as a wt % of total composition) in a range of: about 0.1 to about 9 wt %; about 0.5 to 7 wt %; or about 1 to about 6 wt %. In another example, the combined amount of the thermal stability agents (as a wt % of total composition) is provided in a range of: about 0.5 to about 7 wt %; about 1 to 7 wt %; or about 2 to about 7 wt %. For the recited amounts of thermal stability agents, the conducting polymer composition is optionally in the form of a liquid formulation or in the form of a dry film coating.

In one example, the formulation comprises one of more first stability agents. In another example, the formulation comprises one of more first stability agents and one or more second stability agents. For example, the formulation comprises one or more first thermal stability agents selected from an alkali metal salt, and optionally an amphoteric metal oxide, and one or more second thermal stability agents selected from an antioxidant.

In one example, the combined amount of the one or more first thermal stability agents (as a weight % of total formulation) is about 2 wt % to about 7 wt %. For example, the combined amount of the one or more first thermal stability agents (as a weight % of total formulation) is about 5 wt %.

In one example, the combined amount of the one or more second thermal stability agents (as a weight % of total formulation) is between about 0.5 wt % and about 3 wt %. For example, the combined amount of the one or more second thermal stability agents (as a weight % of total formulation) is about 1 wt %.

In one example, the amount of amphoteric metal oxide (as a weight % of total formulation), when present in the formulation, is less than about 3 wt %.

In other examples, one or more of the thermal stability agents (or all of the thermal stability agents), is/are present in an amount (as a wt % of total composition) in an amount of at least about: 0.1 wt %, 0.2 wt %, 0.3 wt %, 0.4 wt %, 0.5 wt %, 1 wt %, 1.5 wt %, 2 wt %, 2.5 wt %, 3 wt %, 3.5 wt %, 4 wt %, 4.5 wt %, 5 wt %, 5.5 wt %, 6 wt %, 6.5 wt %, 7 wt %, 7.5 wt %, 8 wt %, 8.5 wt %, or 9 wt; or less than about: 0.2 wt %, 0.3 wt %, 0.4 wt %, 0.5 wt %, 1 wt %, 1.5 wt %, 2 wt %, 2.5 wt %, 3 wt %, 3.5 wt %, 4 wt %, 4.5 wt %, 5 wt %, 5.5 wt %, 6 wt %, 6.5 wt %, 7 wt %, 7.5 wt %, 8 wt %, 8.5 wt %, or 9 wt %; and any range provided by a combination of any two upper and/or lower amounts thereof. In one example, the total amount of the first and second thermal stability agents (as a weight % of total formulation) is less than about 9 wt %.

In another example, the composition is a liquid formulation comprising the one or more conducting polymers, the one or more of the thermal stability agents, according to any aspects or examples thereof as described herein. In another example, the one or more thermal stability agents are provided as a suspension or a solid to the liquid formulation. In another example, the one or more of the first and second thermal stability agents present in the liquid formulation is provided as a suspension or a solid to the liquid formulation.

### Alkali Metal Salt

In one example, at least one alkali metal salt is present in a composition as described herein.

In one example, the alkali metal salt comprises cation of lithium (Li), sodium (Na), or potassium (K), beryllium (Be), magnesium (Mg) and/or calcium (Ca).

In one example, the counter ion for the metal cation in at least one alkali metal salt comprises: a hydroxide, a carbonate, a stearate, a borosilicate, a bicarbonate, a metasilicate, a phosphate, and/or a hydrogen phosphate. In another example, the counter ion for the metal cation in the alkali metal salt comprises: a carbonate, a bicarbonate, a phosphate, and/or a hydrogen phosphate. In yet another example, the counter ion for the metal cation in the alkali metal salt comprises a carbonate. Examples of alkali metal salts include, but are not limited to: calcium carbonate (e.g., Omyacarb® 1 μm) optionally surface treated (e.g. Omyacarb® 1T 1 μm); calcium borosilicate (e.g., Halox®); calcium stearate; and/or calcium silicate Ca₂SiO₄ or wollastonite.

In one example, the alkali metal salt has an average particle size in a range of: about 0.5 μm to about 5 μm; about 0.5 μm to about 4 μm; about 0.5 μm to about 3 μm; about 0.5 μm to about 2 μm; or about 0.5 μm to about 1 μm. In another example, the alkali metal salt has an average particle size of less than about: 5 μm, 4 μm, 3 μm, 2 μm, 1 μm, or 0.5 μm. For example, the alkali metal salt has an average particle size of less than about 2 μm. In a preferred example, the alkali metal salt has an average particle size of less than about 1 μm.

For example, at least one alkali metal salt that is a calcium carbonate is present in a composition which is a liquid formulation as described herein, wherein the calcium carbonate has an average particle size of 1 μm.

### Amphoteric Metal Oxide

In one example, at least one amphoteric metal oxide is present in a conducting polymer composition as described herein.

In another example, the conducting polymer composition comprises at least one amphoteric metal oxide which is an oxide of: zinc, cerium, zirconium, titanium, magnesium, yttrium, aluminium; and/or or silicon. Examples include, but are not limited to: zirconia (ZrO₂), titanium oxide (TiO₂), magnesium oxide (MgO), yttrium oxide (Y₂O₃), aluminium oxide (Al₂O₃), carbosil fumed silica, silicon oxide (e.g., TS-720), zinc oxide and/or cerium oxide. In another example, the composition comprises zinc oxide (ZnO) and/or cerium oxide (CeO₂). In yet another example, the composition comprises zinc oxide.

In another example, the amphoteric metal oxide has a mean particle size which is less than about: 5 μm, 4 μm, 3 μm, 2 μm, 1 μm, 950 nm, 900 nm, 850 nm, 800 nm, 750 nm, 700 nm, 650 nm, 600 nm, 550 nm, 500 nm, 450 nm, 400 nm, 350 nm, 300 nm, 250 nm, 200 nm, 150 nm, 100 nm, 50 nm, 40 nm, 30 nm, 20 nm, or 10 nm. Alternatively the amphoteric metal oxide has a mean particle size in a range of: about 10 nm to about 100 nm; about 20 nm to about 90 nm; about 30 to about 80 nm; or about 60 to about 70 nm. For example, the amphoteric metal oxide has a mean particle size in a range of about 30 nm to about 50 nm.

In one example one or more of amphoteric metal oxides is surface treated, for example a surface treatment comprising a polymeric dispersant. It will be appreciated that one or more advantages of the present disclosure according to at least some embodiments or examples as described herein is that surface treatment may provide the surface of the metal oxide hydrophobic and can aid in dispersion.

### Antioxidant

In one example, at least one antioxidant is present in a conducting polymer composition as described herein. In another example, at least two antioxidants (for example a primary and a secondary antioxidant) are present in a conducting polymer composition as described herein. One or more primary antioxidants could be added to act as radical scavengers to remove radicals, such as peroxy radicals. The primary antioxidants may be sacrificial and once partially or fully consumed, one or more polymers present in a conducting polymer composition may begin to degrade. One or more secondary antioxidants could be added to remove harmful species, such as organic hyperoxides, that may be formed by the action of primary antioxidants.

Examples of antioxidants include, but are not limited to: substituted (hindered) phenols optionally comprising propionate groups, phosphites P(OR)₃ wherein each R is independently an aryl or phenyl group, organosulphurs including thioethers, thiols, disulphides and combinations thereof.

In one example, the conducting polymer composition comprises at least one hindered phenol antioxidant comprising at least one 3,5-di-tert-butyl-4-hydroxyphenyl group.

In another example, the conducting polymer composition comprises one or more compounds selected from: pentaerythritol tetrakis(3-(3,5-di-tert-butyl-4-hydroxyphenyl)propionate) (e.g., Irganox 1010), n-octadecyl (3-[3,5-di-tert-butyl-4-hydroxyphenyl]propionate) (e.g., Irganox 1076), ethylene bis (oxyethylene) bis-(3-(5-tert-butyl-4-hydroxy-m-tolyl)-propionate) (e.g., Irganox 245) and combinations thereof.

In yet another example, the composition comprises one or more compounds selected from: bis(2,4-dicumylphenyl) pentaerythritol diphosphate (e.g., Doverphos 9228), distearyl pentaerythritol diphosphite (e.g., Doverphos S-682), didodecyl 3,3′-thiodipropionate, tris(2,4-ditert-butylphenyl) phosphite (e.g., Irganox 168), and combinations thereof.

### Solvents

The conducting polymer compositions as disclosed herein is present in one or more solvents. The one or more solvents may be selected to provide a fluidic carrier for the one or more conducting polymers in the compositions as described herein.

It will be appreciated that the conducting polymers as described herein provide solution processable conducting polymers. The “solution processable” conducting polymers refer to conducting polymers that are soluble in one or more solvents, for example where at least about 95 wt % of the conducting polymer is dissolved in one or more solvents. For example, the polyaniline conducting polymer solution has greater than 95% of a polyaniline salt dissolved in the one or more solvent (e.g. organic solvent such as toluene). The solvent may be provided by one or more organic solvents as described herein. In another example, the organic solvent in an aromatic organic solvent. In another example, the organic solvent is a non-aqueous organic solvent.

The organic solvents can be selected from the group comprising: aromatics, halogenated aromatics (for example chlorinated aromatics), halogenated aliphatic hydrocarbons (for example chlorinated aliphatic hydrocarbons), aliphatic hydrocarbons, glycols, ethers, glycol ethers, esters, alcohols, ketones, and combinations thereof. It will be appreciated that the alcohols may be water immiscible alcohols having at least a medium alkyl chain or aryl group. The water immiscible alcohols can be n-butanol or larger alkyl chain alcohols. It will be appreciated that the ketones may be water immiscible ketones having at least medium chain ketones such as methyl ethyl ketone or ketones with larger alkyl chains.

The organic solvent can be selected from the group comprising: aromatics, halogenated aromatics, halogenated aliphatic hydrocarbons, aliphatic hydrocarbons, glycols, ethers, glycol ethers, esters, alcohols, ketones, and any combinations thereof. In another example, the organic solvent is selected from aliphatic or aromatic hydrocarbons (e.g. toluene and/or naphtha).

In another example, the organic solvent is a non-aqueous organic solvent selected from: toluene, xylene, mesitylene, cymene, terpenes and combinations thereof. In another example, the organic solvent is a non-aqueous organic solvent selected from an aromatic hydrocarbon, for example, toluene and xylene. In another example, the organic solvent is a cyclic amide, for example, n-methyl-2-pyrrolidone.

The organic solvent can also be selected to dissolve an acid dopant (i.e., protonic acid), for example a protonic acid of DNNSA can be provided in the organic solvent such as glycol ethers (e.g., 2-butoxyethanol), hydrocarbons (e.g., heptane), or aromatic hydrocarbons (e.g., toluene and/or xylene). In one example, the acid dopant is dissolved in toluene.

Suitable exemplary liquid solvents include aromatics, such as xylene, toluene or alkylnaphthalenes; chlorinated aromatics or chlorinated aliphatic hydrocarbons, such as chlorobenzenes, chloroethylenes or methylene chloride; aliphatic hydrocarbons, such as cyclohexane or paraffins, for example mineral oil fractions; alcohols, such as butanol, isobutanol, or glycol and also their ethers and esters, such as 2-butoxy ethanol; ketones, such as methyl ethyl ketone, methyl isobutyl ketone or cyclohexanone. For example, the organic solvent is toluene. It will be appreciated that the polyaniline or polyaniline salt is dissolved in the organic solvent, i.e. toluene. For example, the polyaniline conducting polymer solution has greater than 95% of a polyaniline salt dissolved in the organic solvent.

In some examples, organic solvents may contain less than about 800 ppm of water, for example less than about 700 ppm, about 600 ppm, about 500 ppm, about 400 ppm, about 300 ppm, about 200 ppm, or about 100 ppm water. Anhydrous forms of the solvents may also be used. For example, the organic solvent is substantially free of water.

The solvents may contain incidental impurities, for example in an amount (wt % of the total formulation) is less than about 2, 1, 0.5, 0.1, 0.05, 0.01, 0.005, or 0.001 wt %.

The solvent(s) may be present in an amount (based on the total weight of the formulation or the components thereof) of less than about: 99 wt %, 98 wt %, 95 wt %, 90 wt %, 85 wt %, 80 wt %, 75 wt %, 70 wt %, 65 wt %, 60 wt %, 55 wt %, 50 wt %, 45 wt %, or 40 wt %. In one example, the composition comprises one or more organic solvents, wherein the amount of organic solvent is present in an amount (by wt % of total formulation) in a range of: about 35 to about 99 wt %; about 50 to about 90 wt %; or about 35 to about 60 wt %. In another example the amount of organic solvent is present in an amount (by wt % of total formulation) of at least about: 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, 90 wt %; or 95 wt %. The solvent(s) may be in a range provided by any two of these upper and/or lower values.

### Conducting Polymer

The compositions described herein comprise one or more conducting polymers. It will be appreciated that the conducting polymers can provide solution processable conducting polymers. The “solution processable” conducting polymers refer to conducting polymers that are soluble in one or more solvents. For example, the conducting polymer salt can be provided wherein at least about: 0.1. 0.5, 1, 5, 10, 25, 30, 35, 40, 45, or 50 grams of the conducting polymer salt is soluble in 100 mL of an organic solvent when measured at standard room temperature and pressure.

It will be appreciated that conducting polymers are polymers with conjugated chain structures. It will also be appreciated that, unless otherwise defined, a conducting polymer refers to any organic polymer or organic copolymer that is capable of conducting electricity, and may for example include a polymer that is a semi-conductor. A conducting polymer may require further processing to provide desired conductance properties. One example of a conducting polymer is a polyaniline salt.

It will be appreciated that the conducting polyaniline includes polymeric polyaniline that is doped with a protonic acid and is in the form of a polyaniline salt.

The polyaniline conducting polymer may be, for example, a polyaniline emeraldine salt. In one example the solution processable conducting polymer salt is a solution processable conducting polymer sulfonate salt. The salt may be a dinonylnapthalenesulfonate (DNNSA), methanesulfonate (MSA), camphorsulfonate (CSA), p-toluenesufonate (TSA), dodecyl benzene sulfonate (DBSA), dinonylnapthalene sulfonate (DNNSA), polystyrene sulfonate or combinations thereof. In one example, the conducting polymer salt is a dinonylnapthalene sulfonate salt (DNNSA). In another example, the conducting polymer salt is an organic solvent soluble conducting polymer salt. The organic solvent soluble conducting polymer salt may be provided wherein at least about: 0.1. 0.5, 1, 5, 10, 25, 30, 35, 40, 45, or 50 grams of the conducting polymer salt is soluble in 100 mL of an organic solvent (e.g., toluene), when measured at standard room temperature and pressure.

According to some aspects or examples as described herein, the conducting polymer is a solution processable polyaniline emeraldine salt. The solution processable polyaniline salt may be a solution processable polyaniline sulfonate salt. In an aspect or example, the polyaniline salt can be a sulfonate where the sulfonic acid may be methanesulfonic acid (MSA), camphorsulfonic acid (CSA), p-toluenesufonic acid (TSA), dodecyl benzene sulfonic acid (DBSA), dinonylnapthalene sulfonic acid (DNNSA), or combinations thereof. The conducting polymer may be polyaniline methanesulfonate salt (PANI-MSA). The conducting polymer may be polyaniline camphorsulfonate salt (PANI-CSA). The conducting polymer may be polyaniline p-toluenesufonate salt (PANI-TSA). The conducting polymer may be polyaniline dodecyl benzene sulfonate salt (PANI-DBSA). The conducting polymer may be polyaniline dinonylnapthalene sulfonate salt (PANI-DNNSA).

Polyaniline can be in three potential oxidation states: leucoemeraldine (white), emeraldine (green), and pernigraniline (blue/violet). The repeat unit of Formula 1 below provides x as half a degree of polymerization.

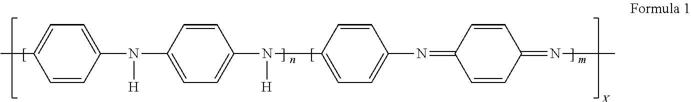

Leucoemeraldine is a fully reduced state (e.g. n=1, m=0). Pernigraniline is a fully oxidized state with imine links instead of amine links (n=0, m=1). The polyaniline can be in one of these three states or a mixture thereof. The emeraldine form of polyaniline (n=m=0.5), is referred to as emeraldine base (EB), if neutral, although when protonated is called emeraldine salt (ES), with the imine nitrogens protonated by an acid. Protonation facilitates delocalising the otherwise trapped diiminoquinone-diaminobenzene state.

In one example, the conducting polymer is a conducting polymer salt, for example a sulphonate salt or a phosphonate salt. In another example, the conducting polymer is a polyaniline sulfonate salt. Examples of salts include: salts of methanesulfonic acid, salts of camphorsulfonic acid, salts of p-toluenesufonic acid, salts of dodecyl benzene sulfonic acid, dinonylnapthalenesulfonate, and combinations thereof.

In another example, the composition comprises a polyaniline sulfonate salt selected from: polyaniline methanesulfonic acid, polyaniline camphorsulfonic acid, polyaniline p-toluenesufonic acid, polyaniline dodecyl benzene sulfonic acid, polyaniline dinonylnapthalenesulfonate, and combinations thereof.

In yet another example the conducting polymer is a polyaniline sulfonate salt which is a polyaniline dinonylnapthalenesulfonate salt.

The polyaniline conducting polymer is an organic solvent soluble polyaniline salt made in-situ by polymerising an aniline monomer with a protonic acid in an organic solvent.

It will be appreciated that the compositions described herein comprise a polyaniline salt. Polymers (e.g., polyaniline (PANT)) are generally not conductive until converted to a salt form (e.g., for example PANI-DNNSA).

In some aspects or examples, each individual polymerised chain of the polyaniline, or any salt thereof, may be independently comprised of individual monomer units of between about 100 to 1500. The number of individual monomer units may be at least about: 100, 200, 300, 400, 500, 600, 700, 800, 900, 1000, 1100, or 1200. The number of individual monomer units may be less than about: 1500, 1400, 1300, 1200, 1100, 1000, 900, 800, 700, 600, or 500. The number of individual monomer units may be between about: 300 to 1400, 500 to 1300, 600 to 1200, or 700 to 1100. The number of individual monomer units in an individual polymerised chain may be in a range provided by any lower and/or upper limit as previously described.

The polyaniline or polyaniline salt may have a number average molecular weight of at least 10,000. For example, number average molecular weight may be at least about 20,000, 30,000, 40,000, 50,000, 60,000, 70,000, or 80,000. The number average molecular weight may be in a range of about 10,000 to 120,000, 20,000 to 115,000, 30,000 to 110,000, 40,000 to 105,000, 50,000 to 100,000, or 60,000 to 100,000. The number average molecular weight may be less than about 120,000, 110,000, 100,000, 90,000, 80,000, 70,000, 60,000, 50,000, or 40,000. The number average molecular weight may be in a range provided by any lower and/or upper limit as previously described.

At least according to some aspects or examples wherein the conducting polymer is a conducting polymer sulphonate salt (e.g. PANI sulphonate salt), the ratio of sulphur to nitrogen (S/N ratio) for the conducting polymer component of the coating may be in a range of about: 0.1 to 0.5, 0.15 to 0.45, or 0.2 to 0.4. The S/N ratio may be less than about: 0.5, 0.45, 0.4, 0.35, 0.3, or 0.25. The S/N ratio may be at least about: 0.2, 0.25, 0.3, 0.35, 0.4, 0.45 or 0.5. The S/N ratio may be in a range provided by any lower and/or upper limit as previously described. For example, the S/N ratio for polyaniline sulphonate salt may be in a range of about: 0.1 to 0.5, 0.15 to 0.45, or 0.2 to 0.4. The S/N ratio for polyaniline sulphonate salt may be less than about: 0.5, 0.45, 0.4, 0.35, 0.3, or 0.25. The S/N ratio for polyaniline sulphonate salt may be at least about: 0.2, 0.25, 0.3, 0.35, 0.4, 0.45 or 0.5. The S/N ratio for polyaniline sulphonate salt may be in a range provided by any lower and/or upper limit as previously described. It will be appreciated that these ratios relate to precipitated solid conducting polymer, and not to cast thin films comprising the conducting polymers.

It will be appreciated that the conducting polymer of the present disclosure may be provided in a high purity, dissolved in an organic solvent. In an aspect or example, the purity of conducting polymer may be in a range from about (by wt %): about 70 to about 99 wt %, about 75 to about 98 wt %, about 80 to about 97 wt %, about 85 to about 96 wt %, or about 90 to 95 wt %. The purity of conducting polymer may be at least (by wt %) about: 70, 75, 80, 85, 90, 95, or 99 wt %. The purity of the conducting polymer may be less than (by wt %) about: 99, 98, 97, 96, 95, 90, 85, 80, or 75 wt %. The purity of conducting polymer may be in a range provided by any lower and/or upper limit as previously described. It will be appreciated that the conducting polymer may be dissolved or dispersed in an organic solvent for coating on a substrate. In other words the conducting polymer and at least according to some aspects or examples is present in a solid phase and is capable of being dissolved or dispersed in an organic solvent such that the conducting polymer can be applied or coated onto a scaffold or substrate.

In one example, a composition as described herein (optionally in the form of a liquid formulation or a dry film composition), comprises a conducting polymer in an amount (wt % of total composition) in a range of: about 1 to about 75 wt %; about 5 to about 70 wt %; about 10 to about 65 about wt %; about 15 to about 50 wt %; about 10 to about 40 wt %; about 40 wt % to about 80 wt %; about 74 to about 85 wt %; or about 45 to about 55 wt %. In another example, a conducting polymer composition as described herein (optionally in the form of a liquid formulation or a dry film composition), comprises a conducting polymer in an amount (wt % of total composition) of at least about: 1 wt %, 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, 85 wt %; or less than about: 80 wt %, 75 wt %, 70 wt %, 65 wt %, 60 wt %, 55 wt %, 50 wt %, 45 wt %; 40 wt %; 35 wt %; 30 wt %, 25 wt %, 20 wt %, 15 wt %, 10 wt %; or 5 wt %. The conducting polymer may be in a range provided by any two of these upper and/or lower amounts.

In one example, the liquid formulation or dry film composition, comprises a conducting polymer in an amount (as a weight % of total formulation) of between about 80 wt % to about 90 wt %. For example, the liquid formulation or a dry film composition, comprises a conducting polymer in an amount (as a weight % of total formulation) of between about 80 wt % to about 85 wt %.

It will be appreciated that the polyaniline conducting polymer is an organic solvent soluble polyaniline conducting polymer salt made in-situ by polymerising an aniline monomer with a protonic acid in an organic solvent (e.g., toluene), and remains dissolved in the organic solvent. In other words the polyaniline conducting polymer, at least according to some aspects or examples, is present in a liquid phase and is dissolved in the organic solvent such that the polyaniline conducting polymer can be applied or coated onto a scaffold or substrate. Advantageously, the polyaniline conducting polymer or polyaniline conducting polymer salt (e.g., PANI-DNNSA) formed in-situ in the organic solvent provides a highly conductive polymer or polymer salt solution, and therefore avoids and/or prevents formation of undesirable undissolved polymer agglomerates. For example, the polyaniline conducting polymer solution has greater than 95% of a polyaniline salt dissolved in the organic solvent. In other words, at least 95 wt % PANI-DNNSA is dissolved in organic solvent and is not present as particles or agglomerates or coiled up in discreet balls of polymer.

In one example, the liquid formulation or a dry film composition, comprises a conducting polymer in an amount (as a weight % in the organic solvent) of between about 30 wt % to about 40 wt %. For example, the liquid formulation or a dry film composition, comprises a conducting polymer in an amount (as a weight % in the organic solvent) of about 35 wt %.

### Film Former

The compositions as described herein may further comprise one or more film formers. For example, the conducting polymer compositions may comprise or consist of a film former and optionally one or more dispersants. In one example, the composition is a curable coating composition comprising or consisting of: one or more conducting polymers, one or more thermal stability agents, a film former, one or more solvents, and optionally one or more dispersants, according to any aspects or examples thereof as described herein.

It will be appreciated that the film former can provide a polymer matrix or dispersion in which the conducting polymer and thermal stability agents are incorporated. The film former (e.g. silicone) can provide further properties to the coatings, such as various mechanical, thermal and stability properties.

In one example, the film former comprises a polymer, optionally an initiator, optionally a chain extender, and optionally a polymerizable monomer, comonomer, or copolymer. The film former may be a silicone or polysiloxane.

The film former may comprise any polymers (e.g., co-polymers) or polymerisable components, such as reactive monomers (e.g., resins) that can form polymers in the coatings. The polymeric constituents may consist of polymers, co-polymers, resins, monomers and co-monomers. Some examples of polymeric constituents include any one or more of polysiloxanes, polyolefins, polyurethanes, polyacrylic acids, polyacrylates, polyethers, polyesters, polyketides, polyurethanes, polyamides, polysilazanes or any co-polymers thereof. In one example, the film former comprises a polymer selected from a siloxane (e.g. silicone), or the components to form a siloxane. The siloxane may be a polysiloxane.

Examples of siloxanes or polysiloxanes may be those substituted with hydrogen or alkyl groups. Other examples include silanamine, 1,1,1-trimethylN-(trimethylsilyl) hydrolysis products with silica, polydimethylsiloxane, methyltrimethoxysilane, octamethyl cyclotetrasiloxane, dimethyldimethoxysilane.

In other examples the film former may be selected from a Nusil™ (R-1009) RTV silicone dispersion coating. The silicone dispersion coating can be a high-strength, flowing, one-part RTV silicone rubber dispersed in VM&P Naphtha. The silicone dispersion coating can comprise an oxime cure system based on 2-butanone, 0,0′,0″-(methylsilylidyne)trioxime and dibutyltin dilaurate catalyst. Another example may be Nusil™ (R-2180) as a two-part silicone elastomer dispersed in xylene with a platinum cure system. Another example is Dowsil™ (3145) RTV MIL-A-46146, which can provide adhesive sealant properties.

It will be appreciated that the “film former” can cover any film former components, for example any monomers, co-monomers, resins, co-polymers, polymers, chain extenders, and initiators, used to provide a film former.

The film former (e.g. silicone) may be provided in the dry film composition or coating in an amount (wt % of total composition or coating) of about 1 to 15, 5 to 15, 1 to 10, or 5 to 10. The film former may be provided in the dry film composition or coating in an amount (wt % of total composition) of at least about 1, 2, 3, 4, 5, 10, 15; or less than about 15, 10, 5, 4, 3, 2, or 1. The film former may be in a range provided by any two of these upper and/or lower amounts.

### Dispersants

The compositions as described herein may optionally comprise one or more dispersants.

Dispersants may include non-ionic surfactants based on primary alcohols (e.g., Merpol 4481, DuPont) and alkylphenol-formaldehyde-bisulfide condensates (e.g., Clariants 1494).

In one example the dispersant may be a Disperbyk™ dispersant, such as Disperbyk 2050, which is wetting and dispersing additive. It can be provided as solution of an acrylate copolymer with basic affinic groups

In another example the dispersant may be Disperbyk™ 2155, which is a wetting and dispersing additive. It can be provided as a solution of a block copolymer with pigment affinic groups.

In another example the dispersant may be Tegomer™ (e.g. M-Si 2650), which is an organo-modified siloxane of comb-like structure containing non-reactive aromatic groups.

In another example the dispersant may be polyglycerin modified silicone such as polyglyceryl-3-polydimethylsiloxyethyldimethicone.

In another example the dispersant may be a silicone acrylate such as acrylates/ethyhexyl acrylate/dimethicone methacrylate copolymer

In another example the dispersant may be a monocarbinol terminated polydimethylsiloxane.

The dispersants (e.g. organosiloxanes) may be provided in the dry film composition or coating in an amount (wt % of total solvent or composition or coating) of about 0.1 to 15, 2 to 15, or 5 to 15. The dispersants may be provided in the dry film composition or coating in an amount (wt % of total solvent or composition) of at least about 0.1, 1, 2, 3, 4, 5, 6, 7, 8, 9, or 10; or less than about 15, 10, 9, 8, 7, 6, 5, 4, 3, or 2. The dispersants may be in a range provided by any two of these upper and/or lower amounts.

### Additives

In one example, the conducting polymer composition, coating or coating composition further comprises or further consists of one or more additional additive(s).

In one example the additive(s) are present in an amount of less than about 10% based on the weight of the composition. For example, the amount of all additives combined, if present, may be provided in an amount of less than about: 2%, 1%, 0.5%, 0.1%, or 0.05%. The amount of all additive(s), if present, may be provided in an amount (based on the total weight of composition) of a range between any two of the above values, for example between about 0.01% to about 2%, between about 0.05% to about 1%, between about 0.1% to about 2%, or between about 0.5% to about 2%.

Any reference to “substantially free” generally refers to the absence of a compound in the composition other than any trace amounts or impurities that may be present, for example this may be an amount by wt % in the total composition of less than about: 1 wt %, 0.1 wt %, 0.01 wt %, 0.001 wt %, or 0.0001 wt %. The compositions as described herein may also include, for example, impurities in an amount by wt % in the total composition of less than about: 2 wt %, 1 wt %, 0.5 wt %, 0.1 wt %, 0.01 wt %, 0.001 wt %, or 0.0001 wt %.

It will be appreciated that film formers, dispersant or other additives if present are different chemical components to the thermal stability agents as described in this disclosure.

### Liquid Formulations

The composition is in the form of a liquid formulation. The liquid formulation can comprise one or more polyaniline conducting polymers in an organic solvent, and one or more thermal stability agents, according to any aspects or examples thereof as described herein.

It will be appreciated that the conducting polymer can provide good solution processability such that its soluble in the one or more solvents as described herein. In one example, the one or more solvents are organic solvents according to any aspects or examples thereof as described herein. For example, the organic solvent is selected from an aromatic organic solvent. In another example, the organic solvent is toluene. In one example, the conducting polymer is an organic solvent soluble conducting polymer salt made in-situ by polymerising an aniline monomer with a protonic acid in an organic solvent (e.g., toluene).

The thermal stability agents (the first and/or second thermal stability agents) can be added to the conducting polyaniline in organic solvent to form a dispersion in the organic solvent.

The inventors have unexpectedly found that the formulation, as described herein, comprising a polyaniline conducting polymer (e.g., PANI-DNNSA) in organic solvent (e.g., toluene) with one or more thermal stability agents, can significantly improve conductivity of the coating when compared to a formulation consisting of polyaniline conducting polymer (e.g., PANI-DNNSA) alone in organic solvent (e.g., toluene).

In one example, the liquid formulation as described herein can be used to form a conductive coating (dry film coating) that is at least 5 times more conductive than a coating formed using a formulation consisting of a polyaniline conducting polymer in organic solvent. For example, the liquid formulation as described herein can be used to form a polyaniline conductive coating (dry film coating) that is at least 10 times more conductive than a coating formed using a formulation consisting of a polyaniline conducting polymer in organic solvent.

In another example, the liquid formulation comprises (based on wt % of total formulation):
any one or more of the conducting polymers in a combined amount of about 80 to 93 wt % in an organic solvent;
any one or more of the thermal stability agents in a combined amount of about 2 to 7 wt %;
optionally one or more film formers in a combined amount of about 1 to 10 wt %; and
optionally one or more dispersants in a combined amount of about 0.1 to 15 wt %.

In another example, a liquid formulation is provided comprising (wt % of total formulation) one or more of:
a conducting polyaniline salt in an amount of about 80 to 90 wt % in an organic solvent;
one or more of first thermal stability agents in a combined amount of about 2 to 7 wt %;
one or more of second thermal stability agents in a combined amount of about 0.5 to 3 wt %;
optionally a silicone film former in a combined amount of about 5 to 15 wt %; and
optionally an organosiloxane dispersant in a combined amount of about 0.1 to 25 wt %.

The conducting polymer may be provided in the liquid formulation in an amount (wt % of total formulation or composition in an organic solvent) of about 1 to 93, 5 to 85, 10 to 80, 15 to 60, or 20 to 50. The conducting polymer may be provided in the liquid formulation in an amount (wt % of total formulation or composition) of at least about 1, 5, 10, 15, 20, 25, 30, 35, 40, 45, 50, 55, 60, 65, 70, 75, 80, 85, or 90; or less than about 90, 85, 80, 75, 70, 65, 60, 55, 50, 45, 40, 35, 30, 25, 20, 15, 10, or 5. The conducting polymer may be in a range provided by any two of these upper and/or lower amounts. For example, the amount of the polyaniline conducting polymer (as a weight % of total formulation) provided in the organic solvent may be between about 80 wt % to about 90 wt %. In a preferred example, the amount of the polyaniline conducting polymer (as a weight % of total formulation) provided in the organic solvent may be between about 80 wt % to about 85 wt %.

The thermal stability agents may be provided in the liquid formulation in an amount (wt % of total formulation or composition) of about 1 to 7, or 2 to 7. The thermal stability agents may be provided in the liquid formulation in an amount (wt % of total formulation or composition) of at least about 0.1, 0.5, 1, 2, 3, 4, 5, 6, 7, 8, or 9; or less than about 9, 8, 7, 6, 5, 4, 3, 2, 1, or 0.5. The thermal stability agents may be in a range provided by any two of these upper and/or lower amounts.

In one example, the one or more first thermal stability agents may be provided in the liquid formulation (as a weight % of total formulation) in a combined amount between about 2 wt % to about 7 wt %. In one example, the one or more first thermal stability agents may be provided in the liquid formulation (as a weight % of total formulation) in a combined amount of about 5 wt %.

In one example, the one or more second thermal stability agents may be provided in the liquid formulation (as a weight % of total formulation) in an amount between about 0.5 wt % to about 3 wt %. In one example, the one or more second thermal stability agents may be provided in the liquid formulation (as a weight % of total formulation) in a combined amount of about 1 wt %.

In one example, the first and second thermal stability agent may be provided in the liquid formulation (as a weight % of total formulation) in a total amount of less than about 9 wt %.

The film former (e.g. silicone) may be provided in the liquid formulation in an amount (wt % of total formulation or composition) of about 1 to 15, 1 to 14, or 1 to 10. The film former may be provided in the liquid formulation in an amount (wt % of total formulation or composition) of at least about 2, 5, 10, or 15; or less than about 20, 15, or 10. The film former may be in a range provided by any two of these upper and/or lower amounts. For example, the film former (e.g. silicone) may be provided in the liquid formulation in an amount (wt % of total formulation) of about 5 wt % to about 15 wt %. In one example, the film former (e.g. silicone) may be provided in the liquid formulation in an amount (wt % of total formulation) of about 10 wt %.

The dispersants and/or additives when present, will be in amounts disclosed above.

### Films and Coatings

The compositions as described herein may be provided in the form of a film, such as a dry film composition or coating.

In one example, the dry film composition comprises (based on wt % of total composition):
any one or more of the conducting polymers in a combined amount of about 80 to 93 wt %;
any one or more of the thermal stability agents in a combined amount of about 4 to 20 wt %;
optionally one or more film formers in a combined amount of about 5 to 20 wt %; and
optionally one or more dispersants in a combined amount of about 0.1 to 15 wt %.

The conducting polymer may be provided in the dry film composition or coating in an amount (wt % of total composition or coating) of about 1 to 90, 5 to 80, 10 to 70, 15 to 60, or 20 to 50. The conducting polymer may be provided in the dry film composition or coating in an amount (wt % of total composition) of at least about 1, 5, 10, 15, 20, 25, 30, 35, 40, 45, 50, 55, 60, 65, 70, 75, 80, 85, or 90; or less than about 90, 85, 80, 75, 70, 65, 60, 55, 50, 45, 40, 35, 30, 25, 20, 15, 10, or 5. The conducting polymer may be in a range provided by any two of these upper and/or lower amounts. For example, the amount of the conducting polymer (as a weight % of total formulation) provided in the liquid formulation may be between about 80 wt % to about 90 wt %. In a preferred example, the amount of the conducting polymer (as a weight % of total formulation) provided in the liquid formulation may be between about 80 wt % to about 85 wt %.

The thermal stability agents may be provided in the dry film composition or coating in an amount (wt % of total composition or coating) of about 4 to about 20, or about 4 to 20. The thermal stability agents may be provided in the dry film composition or coating in an amount (wt % of total composition) of at least about 4, 5, 6, 7, 8, 9, 10, 11, 12, 13, 14, 15, 16, 17, 18, 19, or 20; or less than about 20, 19, 18, 17, 16, 15, 14, 13, 12, 11, 10, 9, 8, 7, 6, 5, or 4. The thermal stability agents may be in a range provided by any two of these upper and/or lower amounts.

In one example, the one or more first thermal stability agents may be provided in the liquid formulation (as a weight % of total formulation) in a combined amount between about 4 wt % to about 15 wt %. In one example, the one or more first thermal stability agents may be provided in the liquid formulation (as a weight % of total formulation) in a combined amount of about 15 wt %.

In one example, the one or more second thermal stability agents may be provided in the liquid formulation (as a weight % of total formulation) in an amount between about 4 wt % to about 15 wt %. In one example, the one or more second thermal stability agents may be provided in the liquid formulation (as a weight % of total formulation) in a combined amount of less than about 15 wt %.

In one example, the first and second thermal stability agent may be provided in the liquid formulation (as a weight % of total formulation) in a total amount of less than about 20 wt %.

The film former (e.g. silicone) may be provided in the dry film composition in an amount (wt % of total composition or coating) of about of about 1 to 20, 5 to 20, or 10 to 20. The film former may be provided in the dry film composition or coating in an amount (wt % of total composition) of at least about 5, 10, 15, 20 or less than about 20, 15, or 10. The film former may be in a range provided by any two of these upper and/or lower amounts. The film former may be in a range provided by any two of these upper and/or lower amounts. For example, the film former (e.g. silicone) may be provided in the liquid formulation in an amount (wt % of total formulation) of about 10 wt % to about 20 wt %. In one example, the film former (e.g. silicone) may be provided in the liquid formulation in an amount (wt % of total formulation) of about 20 wt %.

The dispersants and/or additives when present, will be in amounts disclosed above.

The dry film composition or coating may contain residual solvent or impurities in relatively small amounts, for example solvent in an amount of less than (by wt % of total composition or coating) about: 1, 0.5, or 0.1 wt %.

The coating compositions described herein can be provided as a coating formulation for commercial and industrial application. A coating formulation does not require dissolution of the polyaniline conducting polymer salt in a solvent as the polyaniline salt is already prepared in an organic solvent, and used in the organic solvent (e.g. toluene) that it is prepared in. A liquid formulation as described above can be prepared by addition of thermal stability agents, film formers and optional dispersants and/or additives added into the organic solvent that the polyaniline conducting polymer salt is dissolved in without further dissolution or additional solvents being used. A key advantage of the liquid formulation described herein is that it can be used without further dissolution or manipulation as a coating formulation.

In one example, the liquid formulation as described herein can be used to form a conductive coating (dry film coating) that is at least 5 times more conductive than a coating formed using a formulation consisting of a conducting polymer in organic solvent. For example, the liquid formulation as described herein can be used to form a conductive coating (dry film coating) that is at least 10 times more conductive than a coating formed using a formulation consisting of a conducting polymer in organic solvent.

### Coating System

Disclosed herein is a coating layer provided by the compositions as described herein, which may form part of a coating system.

Also disclosed herein is a substrate comprising one or more coating layers, wherein at least one of the coating layers comprises a composition as described herein.

Also disclosed herein is a coating applied to an optionally coated substrate, wherein the coating comprises any composition or coating thereof as described herein.

Also disclosed herein is a coating system comprising:
(i) an optionally coated substrate;
(ii) one or more optional post coating layers; and
(iii) one or more layers located between (i) and (ii) comprising a composition as described herein.

It will be appreciated that the coating may comprise or consist of a coating composition thereof, according to any aspects or examples as described herein.

In one example, a coating or coating layer described herein is an antistatic coating.

In another example, a coating or coating layer described herein comprises a polymer, for example a polysiloxane.

In another example, a coating or coating layer as described herein has a thickness in a range of about 1 to about 10 or: at least about: 1 μm, 2 μm, 3 μm, 4 μm, 5 μm, 6 μm, 7 μm, 8 μm, 9 μm, or 10 μm.

Suitable substrates include metals and metal alloys (e.g. steel or aluminium), and composites, such as epoxy fibreglass sheets, carbon fibre reinforced composites, Teflon, or glass.

For example, a coating may be applied to an optionally coated substrate, wherein the coating comprises or consists of a composition according to any aspects, embodiments or examples as described herein.

In one example the composition is in the form of a coating having a resistance of less than: about 200 MΩ, about 150 MΩ, about 100 MΩ, about 50 MΩ, about 10 MΩ, or about 5 MΩ.

In one example the resistance is substantially the same over a period of time, for example, about 12 hours, about 24 hours, about 48 hours, about 72 hours, about 96 hours, or about 1 week.

In another example, the composition is in the form of a coating having:
(a) a resistance of less than: about 200 MΩ, about 150 MΩ, about 100 MΩ, about 50 MΩ, about 10 MΩ, or about 5 MΩ;
(b) in a temperature range or at an elected temperature;
(c) for a period of time,
   wherein optionally:
      (i) the temperature range or elected temperature is in a range of: about 70° C. to about 300° C., about 70° C. to about 250° C., about 70° C. to about 200° C., about 70° C. to about 150° C., about 70° C. to about 100° C., about 70° C. to about 300° C., about 100° C. to about 300° C., about 150° C. to about 300° C., about 200° C. to about 300° C., about 250° C. to about 300° C.; or at a temperature of at least about: 70° C., 90° C., 110° C., 130° C., 150° C., 170° C., 190° C., 210° C., 230° C., 250° C., 270° C.; or 290° C.;
      (ii) the period of time is: at least: about 12 hours, about 24 hours, about 48 hours, about 72 hours, about 96 hours, or about 1 week; and/or
      (iii) any analysis is conducted in air.

### Processes for Preparing and Applying Coatings

The coating compositions described herein can be provided as a coating formulation for commercial and industrial application.

In another aspect, embodiment or example, there is provided a process for preparing a liquid formulation, comprising the steps of: mixing (i) one or more first thermal stability agents selected from an alkali metal salt, and optionally an amphoteric metal oxide and (ii) one or more second thermal stability agents selected for an antioxidant with (iii) a solution processable polyaniline conducting polymer that is dissolved in an organic solvent, to form the liquid formulation, wherein the polyaniline conducting polymer is an organic solvent soluble polyaniline conducting polymer salt made in-situ by polymerising an aniline monomer with a protonic acid in the organic solvent, wherein the combined amount of the one or more first thermal stability agents (as a weight % of total formulation) is about 2 wt % to about 7 wt %, wherein the total amount of the first and second thermal stability agents (as a weight % of total formulation) is less than about 9 wt %, and wherein the polyaniline conducting polymer solution has greater than 95% of a polyaniline salt dissolved in the organic solvent. The polyaniline salt remains dissolved in the organic solvent even after addition of the thermal stability agents. In one example, the process, further comprises (iv) mixing one or more film formers into the liquid formulation. It will be appreciated that the process for preparing the liquid formulation as described in any one or more aspects, embodiments or examples, can be used form a conductive coating composition. In one example, the polyaniline conducting polymer that is dissolved in an organic solvent is passed through a filter of less than about 1 μm pore size prior to addition of the thermal stability agent. In another example, the polyaniline conducting polymer that is dissolved in an organic solvent is passed through a filter of between about 0.005 μm to about 1 μm pore size prior to addition of the thermal stability agent.

The coating composition may be applied in different physical forms.

In one example, a process for preparing a coating system comprises:
(i) applying a coating composition as described herein to an optionally coated substrate; and
(ii) optionally applying one or more post coating layers to the coating present on the optionally coated substrate.

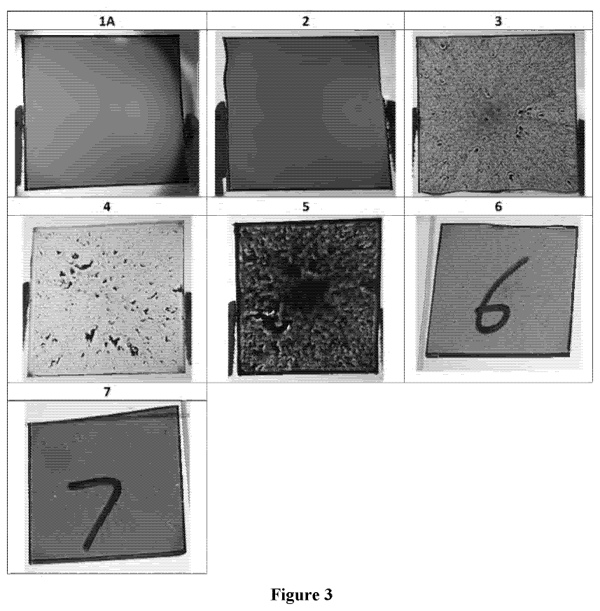

FIG. 3 provides another example of a process for preparing a coating comprising a conducting polymer that is thermally stabilised with one or more thermal stability agents. An optional film former solution can be prepared and optionally dissolved in a solvent. One or more thermal stability agents can be introduced into the film former solution. A solution comprising a conducting polymer can be introduced into the film former solution, if present. If a film former is not used, then a solution comprising one or more thermal stability agents can be introduced into a solution comprising the conducting polymer (or vice versa). The components can be mixed and then coated onto a substrate (or onto a coated substrate). Any solvent present in the coating can be removed (e.g. flash off using heat) prior to any curing step if required (e.g. if film former present requires curing). Any cured coating if present can be optionally annealed.

The coating composition as described herein can be applied onto a coated substrate to form a coating layer by any method known in the coating industry including, but not limited to: spray, drip, dip, roller, brush or curtain coating, especially spray.

The dry thickness of the coating depends on the application. In some aspects, the dry thickness of the coating layer (in microns) is less than about 300, 250, 200, 150, 100, 75, 50, 25, 20, 15, 14, 13, 12, 11, 10, 9, 8, 7, 6, 5, 4, 3, 2, or 1. The dry thickness may be in a range provided by any two of these values.

The coating layer provides effective adhesion on the coated substrate and between any primer, intermediate or post coating layers if present on the coating. In one example, the coating layer is a primer coating. The coating layer may include additional adhesion promoters, such as those described or exemplified herein.

Any suitable method known to those skilled in the art may be used to assess whether the adhesive linkage between the coating layer and other layers (e.g. coated substrate or post coating layer). For example, a cross-hatch test may be used.

The properties of the coating can be tailored by the type and concentration of components and/or additional additives. For example, in one example the final coating may be an antistatic coating. Alternatively, or in addition to antistatic properties, the coatings may show one or more additional characteristics including, but not limited to: thermal stability, low toxicity, environmentally friendly, good processability, miscibility with coating systems, and/or high stability.

### Applications

Disclosed herein is a method for improving stability of a conductive polymer coating comprising providing at least one thermal stability agent to the conductive polymer coating, wherein the thermal stability agent is selected from: an alkali metal salt, an amphoteric metal oxide, an antioxidant, and combinations thereof.

Also disclosed herein is the use of one or more compounds selected from: an alkali metal salt, an amphoteric metal oxide, an antioxidant, and combinations thereof, to improve thermal stability in a coating, for example a conductive polymer coating.

In one example the conductive polymer coating is an antistatic coating.

In one example the conductive polymer coating is used at a temperature in a range of: about 70° C. to about 300° C., about 70° C. to about 250° C., about 70° C. to about 200° C., about 70° C. to about 150° C., about 70° C. to about 100° C., about 70° C. to about 300° C., about 100° C. to about 300° C., about 150° C. to about 300° C., about 200° C. to about 300° C., about 250° C. to about 300° C.; or at a temperature of at least about: 70° C., 90° C., 110° C., 130° C., 150° C., 170° C., 190° C., 210° C., 230° C., 250° C., 270° C.; or 290° C.

In another example the composition or conducting polymer coating used for the electrical de-icing of rotor blades, optionally on fixed wing aircraft.

In yet another example, the composition or conducting polymer coating is used for: radar absorption, lightning strike protection, energy capture and storage, electromagnetic interference (EMI) shielding, antennas, batteries, capacitors, solar control, and/or for anticorrosion coatings.

In still another example, the composition or conducting polymer coating is used for: coating wind turbines for power production.

### Additional Aspects

The present disclosure provides, among others, the following aspects, each of which may be considered as optionally including any alternate aspects.

Clause 1. A composition comprising a solution processable polyaniline conducting polymer and one or more thermal stability agents selected from an alkali metal salt, an amphoteric metal oxide, an antioxidant, or any combinations thereof.

Clause 2. The composition according to Clause 1, wherein the alkali metal salt comprises a metal selected from one or more of lithium (Li), sodium (Na), potassium (K), beryllium (Be), magnesium (Mg), calcium (Ca), and strontium (Sr), and a counter ion for the metal selected from one or more of hydroxide, carbonate, stearate, borosilicate, bicarbonate, metasilicate, phosphate, and hydrogen phosphate.

Clause 3. The composition according to Clause 2, wherein the counter ion for the metal of the alkali metal salt is selected from carbonate, bicarbonate, phosphate, and hydrogen phosphate.

Clause 4. The composition according to Clause 2 or Clause 3, wherein the metal of the alkali metal salt is calcium (Ca).

Clause 5. The composition according to any one of Clauses 1 to 4, wherein the amphoteric metal oxide is an oxide of zinc, cerium, zirconium, titanium, magnesium, yttrium, aluminium, or silicon.

Clause 6. The composition according to any one of Clauses 1 to 5, wherein the amphoteric metal oxide is an oxide of zinc or cerium.

Clause 7. The composition according to any one of Clauses 1 to 6, wherein the amphoteric metal oxide is surface treated, optionally with a polymeric dispersant.

Clause 8. The composition according to any one of Clauses 1 to 7, comprising the antioxidant is a hindered phenol.

Clause 9. The composition according to any one of Clauses 1 to 8, wherein one or more antioxidants are selected from pentaerythritol tetrakis(3-(3,5-di-tert-butyl-4-hydroxyphenyl)propionate), n-octadecyl (3-[3,5-di-tert-butyl-4-hydroxyphenyl]propionate), ethylene bis (oxyethylene) bis-(3-(5-tert-butyl-4-hydroxy-m-tolyl)-propionate), or any combinations thereof.

Clause 10. The composition according to any one of Clauses 1 to 9, wherein one or more antioxidants are selected from bis(2,4-dicumylphenyl) pentaerythritol diphosphate, distearyl pentaerythritol diphosphite, didodecyl 3,3′-thiodipropionate, tris(2,4-ditert-butylphenyl) phosphite, and combinations thereof.

Clause 11. The composition according to any one of Clauses 1 to 10, wherein the polyaniline conducting polymer is a conducting polymer sulphonate salt or a conducting polymer phosphonate salt.

Clause 12. The composition according to any one of Clauses 1 to 11, wherein the conducting polymer is a polyaniline sulfonate salt.

Clause 13. The composition according to any one of Clauses 1 to 12, wherein the polyaniline sulfonate salt is selected from the group consisting of: polyaniline methanesulfonic acid, polyaniline camphorsulfonic acid, polyaniline p-toluenesufonic acid, polyaniline dodecyl benzene sulfonic acid, polyaniline dinonylnapthalenesulfonate, and combinations thereof.

Clause 14. The composition according to any one of Clauses 1 to 13, wherein the polyaniline sulfonate salt is a polyaniline dinonylnapthalenesulfonate salt.

Clause 15. The composition according to any one of Clauses 1 to 14, wherein the composition is a liquid formulation or a dry film coating.

Clause 16. The composition according to any one of Clauses 1 to 15, wherein the combined amount of thermal stability agents (as a weight % of total composition) is between about 0.1 to about 9, about 0.5 to about 9, or about 1 to about 8.

Clause 17. The composition according to any one of Clauses 1 to 16, wherein the amount of the conducting polymer (as a weight % of total composition) is between about 1 to about 85; about 5 to about 80; about 10 to about 75; or about 15 to about 70.

Clause 18. The composition according to any one of Clauses 1 to 17, wherein the amount of the conducting polymer (as a weight % of total composition) is between about 80 to about 85.

Clause 19. The composition according to any one of Clauses 1 to 17, wherein the amount of the conducting polymer (as weight % of liquid formulation thereof) is between about 1 to about 85; about 2 to about 80; or about 3 to about 75.

Clause 20. The composition according to any one of Clauses 1 to 19, wherein the amount of the conducting polymer (as weight % of dry film composition) is between about 1 to about 85, about 5 to about 80, or about 10 to about 75.

Clause 21. The composition according to Clause 1, wherein the thermal stability agent is provided in a particle size of less than about 5 μm.

Clause 22. The composition according to Clause 1, wherein the thermal stability agent is provided in a particle size of between about 1 to 100 nm.

Clause 23. The composition according to any one of Clauses 1 to 22, wherein the composition is a liquid formulation.

Clause 24. The composition according to Clause 23, wherein the organic solvent comprises a solvent selected from: aromatics, halogenated aromatics, halogenated aliphatic hydrocarbons, aliphatic hydrocarbons, glycols, ethers, glycol ethers, esters, alcohols, ketones, or combinations thereof.

Clause 25. The composition according to Clause 23, wherein the organic solvent comprises a hydrocarbon based solvent, optionally an aromatic hydrocarbon, and optionally toluene, xylene or a mixture thereof.

Clause 26. The composition according to any one of Clauses 23 to 25, wherein any one or more of the thermal stability agents present in the liquid formulation is provided as a suspension in the liquid formulation.

Clause 27. The composition according to any one of Clauses 1 to 26, wherein the composition comprises at least one film former.

Clause 28. The composition according to any one of Clauses 1 to 27, wherein the composition comprises a film former that is present in an amount (by weight % of total dry film weight) of between about 1 to about 20 wt %, about 1 to about 15 wt %, or about 1 to about 10 wt %.

Clause 29. The composition according to Clause 39, wherein the film former comprises a silicone or polysiloxane.

Clause 30. The composition according to any one of Clauses 1 to 29, further comprising a dispersant.

Clause 31. The composition according to any one of Clauses 1 to 30, in the form of a coating having a resistance of less than about 100 MΩ, about 50 MΩ, about 10 MΩ, or about 5 MΩ.

Clause 32. The composition according to any one of Clauses 1 to 31, in the form of a coating having a resistance of less than: about 100 MΩ, about 50 MΩ, about 10 MΩ, or about 5 MΩ; at a temperature in a range of about 70° C. to about 300° C., for at least: about 12 hours, about 24 hours, about 48 hours, about 72 hours, about 96 hours, or about 1 week.

Clause 33. A substrate comprising one or more coating layers, wherein at least one of the coating layers comprises a composition as defined by any one of Clauses 1 to 32.

Clause 34. A coating applied to an optionally coated substrate, wherein the coating comprises:
(i) a composition as defined in any one of Clauses 1 to 32.

Clause 35. The coating according to Clause 34, wherein the coating is an antistatic coating.

Clause 36. The coating according to Clause 34 or Clause 35, comprising a polysiloxane.

Clause 37. The coating according to any one of Clauses 34 to 36, wherein the coating has a thickness in a range of about 1 to about 10 μm.

Clause 38. A coating system comprising:
(i) an optionally coated substrate;
(ii) one or more optional post coating layers; and
(iii) one or more layers located between (i) and (ii) comprising a composition as defined in any one of Clauses 1 to 32.

Clause 39. The coating system according to Clause 38, wherein the coating system is an antistatic coating.

Clause 40. The coating according to Clause 38 or Clause 39, comprising a polysiloxane.

Clause 41. The coating of any one of Clauses 34 to 37, or the coating system according to any one of Clauses 38 to 40, wherein the substrate is selected from a metal, metal alloy, polymer, composite, carbon fibre, glass fibre, or silicon based material.

Clause 42. A method for improving stability of a conductive polymer coating comprising providing at least one thermal stability agent to the conductive polymer coating, wherein the thermal stability agent is selected from: an alkali metal salt, an amphoteric metal oxide, an antioxidant, and combinations thereof.

Clause 43. The method according to Clause 42, wherein the conductive polymer coating is a composition according to any one of Clauses 1 to 32.

Clause 44. Use of one or more thermal stability agents selected from: an alkali metal salt, an amphoteric metal oxide, an amphoteric metal hydroxide, an amphoteric metal mineral or clay, an antioxidant, and combinations thereof, to improve thermal stability in a conductive polymer coating.

Clause 45. The use according claim 46, wherein the conductive polymer coating is a composition according to any one of Clauses 1 to 32.

Clause 46. The use according to Clause 44 or Clause 45, wherein the conductive polymer coating is an antistatic coating.

Clause 47. The use according to any one of Clauses 44 to 46, wherein the conductive polymer coating is used at a temperature of at least: about 100° C., about 150° C., about 200° C., about 250° C., or about 300° C.

Clause 48. The use according to any one of Clauses 44 to 47, wherein the resistance of the conductive polymer coating having a resistance of less than: about 100 MΩ, about 50 MΩ, about 10 MΩ, or about 5 MΩ; at a temperature in a range of about 70° C. to about 300° C., for at least: about 12 hours, about 24 hours, about 48 hours, about 72 hours, about 96 hours, or about 1 week.

Clause 49. The use according to any one of Clauses 44 to 47, wherein the conductive polymer coating is used for electrical de-icing, radar absorption, lightning strike protection, energy capture and storage, electromagnetic interference (EMI) shielding, antennas, batteries, capacitors, solar control, or for anticorrosion coatings.

### EXAMPLES

The present disclosure will now be described with reference to the following non-limiting examples and with reference to the accompanying Figures.

### 1. Preparation of Conducting Polymer

A conducting polymer of polyaniline dinonylnaphthalenesulphonic acid salt (PANI-DNNSA) was prepared by continuous flow processes to provide a solution of PANI-DNNSA in a toluene solution.

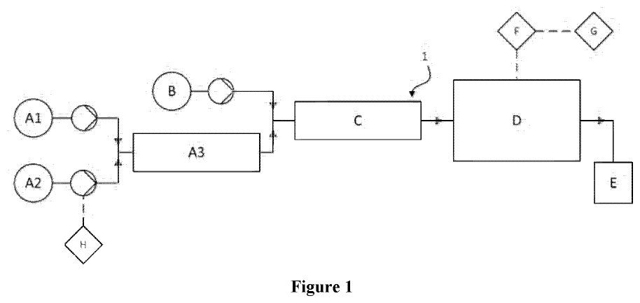

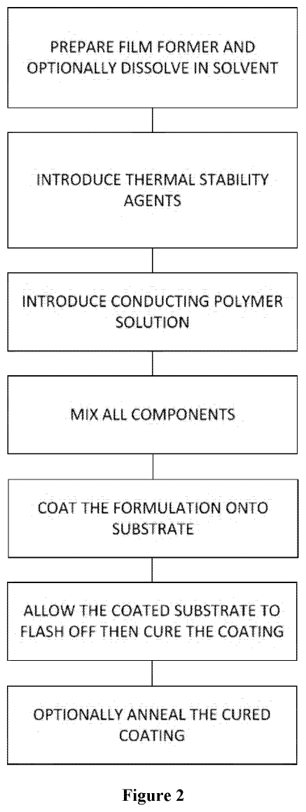

The configuration of the continuous controlled flow process for the synthesis of PANI consisted of two stages. The first stage provides room temperature mixing of the aniline reagents and protonic acid (A1 and A2, FIG. 1) to form an organic stream A3 before this combined organic stream A3 is mixed with the oxidant stream from B generating an emulsion product stream C in the pressurised zone. This emulsion C is then fed into a temperature controlled flow reactor D, downstream of the pressurised zone, where the reaction was allowed to progress with active temperature control and reaction monitoring.

Stage 1: Reagent delivery was achieved using a three pump configuration (see in FIG. 1). Pump P-1 was used to deliver the aniline solution A1, pump P-2 used to deliver DNNSA solution A2 and pump P-3 was used to deliver the ammonium persulfate solution A3. Both aniline and DNNSA are delivered with a Knauer Pump 80P (pumps (P-1 and P-2) capable of operating at flow rates up to 100 mL/min and pressures up to 400 bar. Pump P-3 is a SSI PR-Class Dual Piston Positive Displacement Pump capable of delivering flow rates up to 100 mL/min and pressures of 276 bar. The reagent streams are transferred using PFA tubing (⅛″ OD, 1/16″ ID) obtained from VICI and mixed in a SS Swagelok T-piece. Following this initial mixing the reagents are then passed through SM-1 a 15 cm SS tube ( 3/16″ OD, 3.4 mm ID) fitted with PP high shear static mixers (Cambridge Reactor Design). The solution of aniline and DNNSA is then combined with the APS solution from P-3 and passed through SM-2 a 30 cm SS tube ( 3/16″ OD, 3.4 mm ID) fitted with PP high shear static mixers (Cambridge Reactor Design). A Swagelok R3A-A relief valve was used in order to pressurise Stage 1 which can be adjusted to give system pressures ranging from 3.4 to 24.1 bar. All other plumbing of reactor lines was carried out using standard Swagelok fittings.

Stage 2: The 1 L shell-and-tube continuous reactor (Cambridge Reactor Design) consists of a series of Hastelloy C276 alloy tubes (8 mm OD, 6 mm ID) connected in a serpentine fashion within the reactor shell. The reactor is fitted with static mixers along its length and has a total internal volume of 1 L. Depending on the ancillary equipment used the reactor can operate over a temperature range of −10° C. to 200° C. up to pressures of 25 bar. For the purposes of the current experiments reactor temperature control is provided by a Julabo Presto A40 thermostat capable of operating from −40° C. to 250° C. Monitoring of the internal reactor tube temperature was performed using 4 PT-100 temperature probes connected to position 1, 8, 15 and 24 of the 5×5 array recorded using a OM-DAQPRO-5300 portable data acquisition and logging system. No back pressure regulator (BPR) was used for this section of the reactor.

A 1 L reactor system was cooled to 0° C. before aniline (1.0 eq, neat, 99.5%) was pumped (P-1) at 0.56 ml/min and a DNNSA (1.5 eq, 50% w/w in 2-butoxyethanol) was pumped at 8.71 ml/min (P-2) through static mixer 1 (SM-1) for 1 minute to form an organic stream. Ammonium persulfate (1.2 eq, 1.0 M solution in H₂O) was then introduced at 7.4 ml/min (P-3). The combined reagent stream was then directed through static mixer 2 (SM-2) in order to form an emulsion product stream which then enters the pre-cooled 1 L Salamander Jacketed Flow Reactor with a combined flow rate of 16.67 ml/min in order to give a total residence time of 1 h. Collection of the steady state product was begun after 1 h 16 min. After completion of the steady state operation, P-3 was switched to a water wash followed by switching P-1 and P-2 to toluene. Collection was stopped after 3 h 28 min and the crude product solution diluted with toluene (2.45 L). The aqueous layer was then drained off and the organics washed with 0.1 M H₂SO₄ (3×1.25 L) followed by H₂O (3×1.25 L). The washed organics were then concentrated under reduced pressure and toluene (2.25 L) re-added in order to further dry the organics azeotropically. This drying process was repeated once more before re-adding toluene once more in order to bring the solution back up to the desired concentration (50% w/w).

From a small portion of the PANI-DNNSA concentrate a 70% w/v solution was made up in toluene and a thin film cast. After drying overnight in the oven at 100° C. the film was washed with 2-propanol and allowed to air dry. The resulting thin film had a thickness of 8.25 μm and a conductivity of 10.6 S/cm.

### Thermal Decomposition

Various agents were explored to improve the thermal stability of PANI. Using thermogravimetric analysis-mass spectrometry (TGA-MS) it was established that PANI-DNNSA undergoes thermal decomposition across 3 main stages. The first is loss of trapped or otherwise adsorbed water from the polymer (35-155° C.). Next DNNSA undergoes desulfonation eliminating water and sulfur trioxide (155-322° C.). At elevated temperatures sulfur trioxide may further decompose to sulfur dioxide. Finally, the PANI backbone begins to break apart losing aniline fragments (322-650° C.) with 100% mass loss recorded for temperatures above 650° C. Desulfonation of DNNSA is an equilibrium reaction whereby the presence of water/dilute acid promotes desulfonation. Without wishing to be bound by any theory, it is understood that agents including calcium stearate and CaCO₃ (Omyacarb 2) may react with both free DNNSA as well as other acid species formed during decomposition to improve thermal stability of the conducting polymer. Other agents were also identified to provide improved thermal stability including Al₂O₃(AL-15-25) and Carbosil fumed silica (TS-700).

Agent loadings were calculated based on the amount of DNNSA in the PANI solution (eq) as well as on a weight percent (wt %) basis. Agent loadings were initially very high in order to screen for any positive effect over the performance of unmodified PANI.

Samples were prepared by adding PANI-DNNSA in toluene (4.00 g, 35 wt %) along with the desired agent into a vial and stirring overnight at room temperature. Films were then cast from the resulting solutions using spin coating and placed directly in the oven at 150 C for an initial 0.5 h period which is the reference point for all comparisons of film resistance (Table 1 and FIG. 3).

TABLE 1
Summary of agent concentration used during screening.

| # | Agent | Conc. (wt %) | Conc. (eq) | Amount (g) |
|---|---|---|---|---|
| 1 | Calcium stearate | 3.8 | 0.03 | 0.06 |
| 2 | CaCO₃ (<2 μM) | 17.6 | 0.99 | 0.30 |
| 3 | Diethanolamine | 18.6 | 1.00 | 0.32 |
| 4 | Methyl diethanolamine | 20.5 | 0.99 | 0.36 |
| 5 | Diisopropylamine | 22.7 | 1.01 | 0.41 |
| 6 | TS-720 | 15.9 | 0.53 | 0.26 |
| 7 | Al-15-25 | 18.1 | 1.00 | 0.31 |

Coatings prepared from solutions 1 and 2 (in Table 1) gave transparent films with the agents as solid particulates well dispersed giving the film a matte appearance without any agglomerates (see FIG. 3). Samples 1 and 2 were transparent with no particles visible to the naked eye but had a matte appearance compared to a PANI film with no agent added. Samples 3, 4 and 5 (the amines) showed an immediate reaction with the PANI solution. The solution was observed to thicken and turn blue to varying degrees in each case. Upon casting these films contained large polymer agglomerations (Error! Reference source not found. 3). The film containing CaCO₃ (particle size<2 μm, surface treated) performed very well with a stable resistance over a 24 h period at 150° C. The initial drop in resistance is due likely due to loss of toluene and reaction of CaCO₃ with excess DNNSA. Film resistance after 0.5 h was 2.2 MΩ while after 24 h at 150° C. it was 1.5 MS) with some darkening of the film observed. In reference experiments, untreated PANI films generally see a 20-200 fold increase in resistance over a 24 h period at 150° C. The films containing diisoproylamine and diethanolamine also performed well despite their poor appearance (Error! Reference source not found. 3). These early experiments showed that the addition of some agents such as calcium carbonate to PANI-DNNSA can assist to further stabilize the conductivity of the polymer over 24 h rather than the 4 h recorded for the unmodified polymer. To further investigate the mechanism of this stabilizing effect samples were analyzed by TGA-MS to any changes in mass loss and molecular fragments from samples containing the agent of calcium carbonate (O2T).

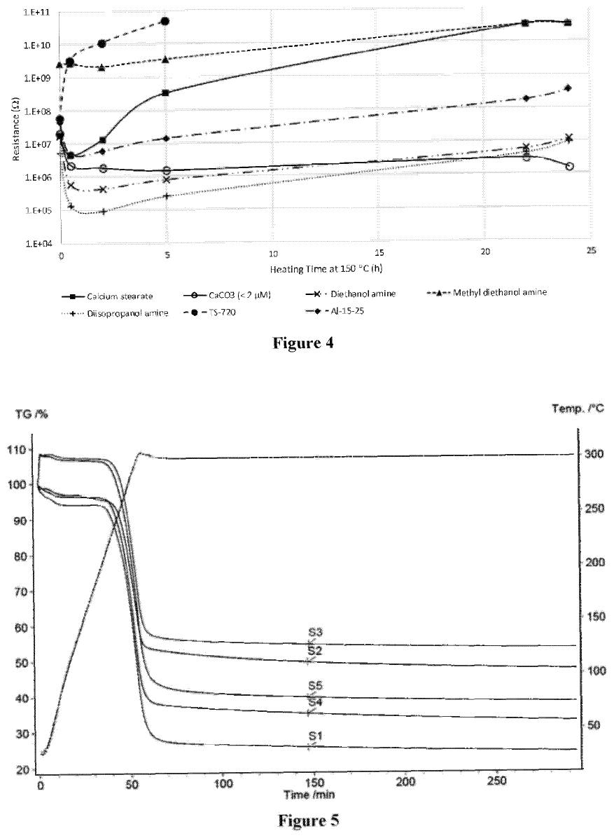

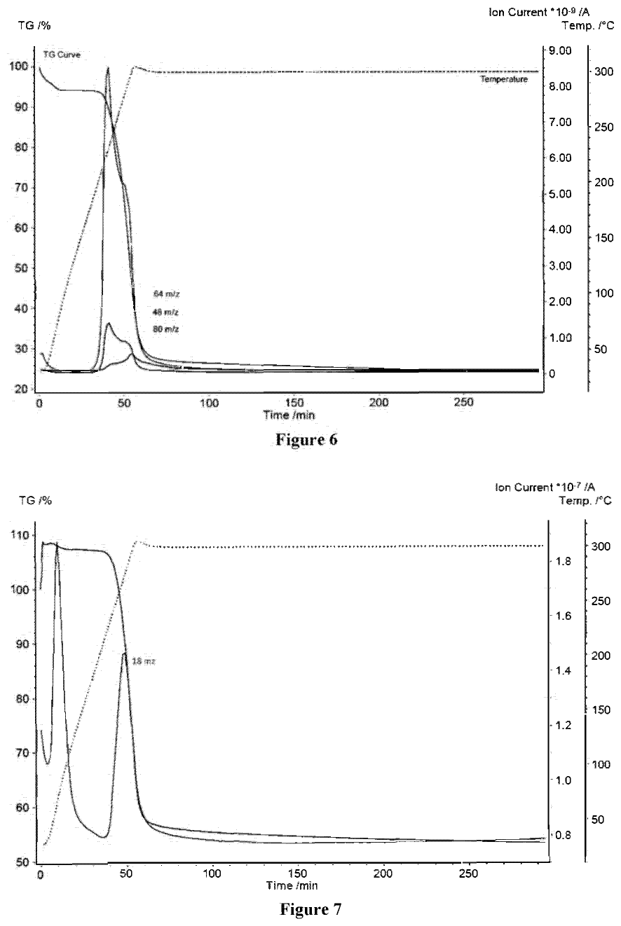

Samples were prepared from PANI-DNNSA 40 wt % with 5 wt O2T added as shown in the table below (Error! Reference source not found. 2, FIGS. 4 and 5). Samples were then homogenized and either cured in air or under N₂ at 150° C. for 30 min. The resulting thin film was then removed from the glass substrate and analyzed by TGA-MS either in air or under argon. The TGA-MS was set to heat samples at 5° C./min for 60 min then holding at 300° C. for a further 4 h.

TABLE 1
Summary of TGA-MS data for samples S1-S5.

| | | | | Dynamic | Isothermal | |
|---|---|---|---|---|---|---|
| | | | | Mass | Mass | |
| | | | | Change | Change | Total - |
| | | Curing | TGA | 30- | 300° C. | Dynamic + |
| Sam- | O2T | Atmo- | Atmo- | 300° C. | for 3 h | Isothermal |
| ple | (wt %) | sphere | sphere | (wt %) | (wt %) | (wt %) |
| S1 | 0 | Air | Air | 62 | 14 | 76 |
| S2 | 5 | Air | Air | 43 | 10 | 53 |
| S3 | 5 | Air | Argon | — | — | — |
| S4 | 5 | N₂ | Air | 56 | 11 | 67 |
| S5 | 5 | N₂ | Argon | — | — | — |

All samples showed a significant mass loss during the dynamic heating cycle (30-300° C.) (FIG. 5). The isothermal stage showed a much smaller mass loss suggesting that most of the thermal de-doping may already be complete by 300° C. (Table 2). A higher mass loss upon heating to 300° C. was observed in samples that were cured under N₂ (S2 vs. S4 and S3 vs. S5). It has previously been shown that PANI-DNNSA conductivity is significantly more stable under N₂. It is therefore assumed that during the curing step where samples were heated to 150° C. for 30 min under either air or N₂ effected this result. Where samples were cured under air it is assumed that much of the volatile material was already lost from the sample prior to analysis by TGA. Conversely the N₂ samples were more stable during curing and the volatiles remained present in the sample. Upon exposure to high temperatures in air the N₂ samples then lost more material than the air samples giving the results shown above. Essentially the N₂ samples had more mass to lose at the beginning of the test. Samples with O2T showed a much lower mass loss than those without O2T (S1 vs. S2). The dynamic mass change for S1 was 62 wt % while S2 only gave a mass change of 43 wt % at the same temperature. S2 was also slightly more stable during isothermal heating (10 wt % vs. 14 wt %). This supports our hypothesis based on the conductivity observations that O2T is reducing the thermal decomposition of PANI-DNNSA. The TGA data supports the finding that the O2T stabilises PANI through slowing desulfonation or through another mechanism, however further support is provided by the MS data. All samples undergo a major mass loss event from 150-300° C. The largest mass loss is typically H₂O followed by SO₂ (m/z 64), SO (m/z 48) and SO₃ (m/z 80). These species are all associated with thermal desulfonation of DNNSA (Error! Reference source not found. 6).

All samples including S3 and S5 gave two clear water signals. The first occurs from T=30-150° C., peaking at T=50° C. This is most likely due to removal of water adsorbed onto the polymer (Error! Reference source not found. 7). The second occurs from T=175-300° C., peaking at T=250° C. This is most likely due to desulfonation of DNNSA and potentially reaction of excess acid with CaCO₃ in samples containing O2T. The second peak coincides with most other peaks including the loss of SO₂, SO and SO₃.

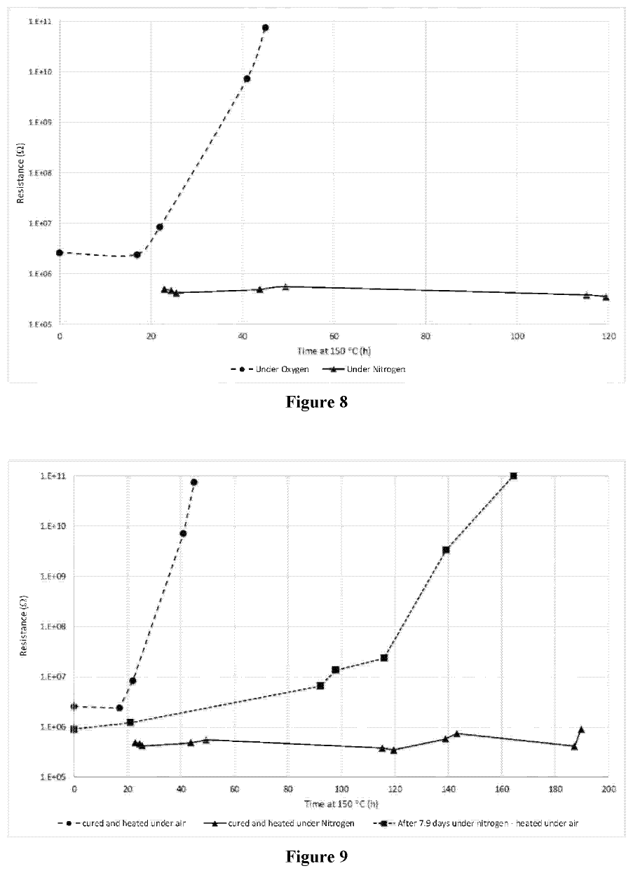

The TGA-MS data demonstrate that oxidation plays a role in decomposition of PANI alongside thermal de-doping. To evaluate the effect of oxidation on PANI conductivity samples containing varying amounts of O2T were placed in a vacuum oven and the oven purged with N₂ before heating to 150° C. While the film resistance increased rapidly in air after 24 h the resistance remained stable under N₂ for over 5 days (FIG. 8).

A fresh batch of samples were prepared with varying levels of O2T and heated at 150° C. under N₂ for up to 7.9 days with no loss in performance measured in films with >5 wt % O2T. This indicates that the O2T can stabilize the PANI to acid degradation, but oxygen also plays a key role in attack of the PANI backbone and ultimate loss of electrical performance. After 7.9 days under nitrogen the same films with varying concentrations of O2T were heated in the presence of air at 150° C. for a further 6.8 days. Here it was observed that these films were relatively stable for up to 3 days before an increase in resistance was measured. This increased stability over films that were placed directly into an oxidising environment may suggest that complete curing of the film can provide some protection against oxidation. As the concentration of O2T was increased the film stability increased up to loadings of 10 wt %. There was nominal difference observed between the 10 and 15 wt % samples. Observations of the PANI films also point to the stabilising effect of O2T. The 10 and 15 wt % samples did not turn black as fast as the films with a lower O2T loading. The 1-5 wt % films generally turned black and became cracked after 80 h at 150° C. The effect of oxygen on the PANI-O2T films was further explored by preparing a fresh film with 5 wt % O2T loading. This was then cured and heated under N₂ (FIG. 9). The sample that was cured under N₂ showed better thermal stability only showing a very slight increase in resistance over a 7-day period (initially 4.5×10⁵Ω increasing to 6.0×10⁵Ω).

It is understood that both CaCO₃ and ZnO react with free DNNSA to form the respective Ca and Zn salts. To gain a better understanding of the stoichiometry required and how this relates to the observed film failure times the concentrations of CaCO₃ (O1) and ZnO were converted from weight percent to mole equivalents. The amount of free DNNSA was calculated based on what would be expected in a 35 wt % PANI solution. Based on XPS data from 10 untreated films an average of 1.37 eq of DNNSA is present relative to aniline with 0.491 eq bound to the polymer in the emeraldine salt (Table 3).

TABLE 3
Equivalents of O1 and ZnO relative to free DNNSA.

| O1 | | | | ZnO | | | |
|---|---|---|---|---|---|---|---|
| C | | | | C | | | |
| (wt | m | n | n (O1)/ | (wt | m | n | n (ZnO)/ |
| %) | (mg) | (mmol) | n(DNNSA) | %) | (mg) | (mmol) | n(DNNSA) |
| 1 | 34 | 0.34 | 0.27 | 0.1 | 3 | 0.04 | 0.03 |
| 2 | 68 | 0.68 | 0.54 | 0.5 | 17 | 0.21 | 0.16 |
| 5 | 176 | 1.76 | 1.40 | 1 | 34 | 0.41 | 0.33 |
| 10 | 375 | 3.75 | 2.98 | 2 | 68 | 0.84 | 0.67 |
| 15 | 600 | 5.99 | 4.77 | 5 | 176 | 2.17 | 1.73 |

Based on previous data obtained for CaCO₃ at various loadings there was a significant increase in failure time for loadings over 1.40 eq (5 wt %). At loadings of 0.54 eq (2 wt %) and below film performance was very poor. The results for formulations containing ZnO were different with loadings below 0.67 eq (2 wt %) having low failure times while loadings of 0.67 eq and above had increasing failure times up to 1.73 eq (5 wt %). There is likely to be a detrimental effect upon adding extremely high amounts of ZnO, but the benefit appears to continue past what was seen with 1.73 eq. The difference between the observed behaviour of CaCO₃ and ZnO may be due to the fact that CaCO₃ is an alkali salt while ZnO is an amphoteric oxide. It may be due to reactivity, solubility or both.

### 2. Preparation of Thermally Stabilised Conducting Polymer Coatings

Various agents were further investigated in order to slow de-sulfonation of the DNNSA dopant and prevent any sides reaction of decomposition by-products with the PANI backbone. Formulations with varying concentrations and agents were prepared using a Chemspeed robotic system. Powder or liquid agents at varying weight percentages to relative to PANI-DNNSA were manually weighed into each vial before being loaded automatically with 4.0 grams of PANI solution (41 wt %) using the viscous liquid gravimetric dispensing unit tool in the Chemspeed robot. The resulting solutions were then homogenized for 3 mins at using a 12 mm diameter homogenizer tool inside the Chemspeed robot (dial setting 30). The coating formulations were then spin coated (40 secs @2000 rpm) within 3 hours onto 2.5 cm 2 glass slides and dried in oven at 150 C for 30 minutes. The resistance of each sample was then recorded over time using a custom designed continuous measurement device capable of withstanding 150° C. temperatures.

The agents investigated in this further study are listed below.
1. O2T—Omyacarb 2 (CaCO3)
2. DEA—Diethanolamine
3. DIPA—Diisopropanolamine
4. SA—Succinic acid
5. CBS—Sodium bisulfite
6. Ci—Carbon filler (Intelliparticle 7284)
7. Cg—Carbon filler (CSIRO)
8. A1-15-25—Aluminum oxide (15-25 nm)

Thin film appearance was highly variable depending on the agent used. PANI films with DEA and DIPA contained large agglomerations of particles and the solution was very viscous with mixtures of liquid and sludgy components as the concentration is increased. Based on these observations this class of amine agents were found to be not suitable. Films with carbon filler (Ci) were uniform but showed particles on the surface as the concentration is increased from 1 wt % to 10 wt % in relation to PANI-DNNSA solution. All samples (excluding O2T) showed significantly increased resistance after 24 h at 150° C. The amines (DEA and DTPA) performed poorly and were not considered for PANI formulations. One agent that was found to be particularly effective was calcium carbonate (O2T). Concentrations of O2T from 1 to 15 wt % were explored. It was found that 5, 10 and 15 wt % samples provided particularly effective stable resistance over 24 h at 150° C.

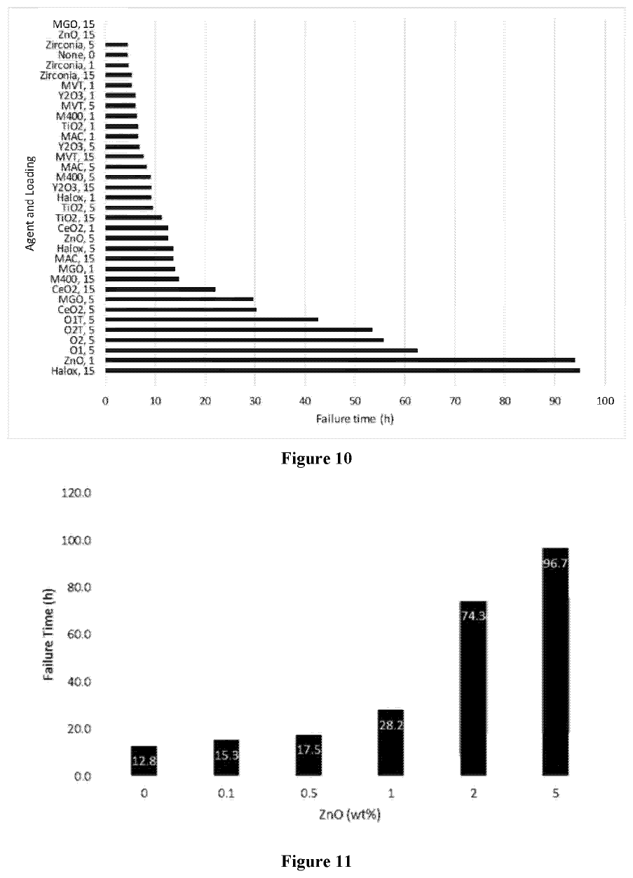

A series of different agents to prevent thermal degradation of PANI were also investigated (Table 4 and FIG. 10 Table 42). Samples were prepared by weighing 4 g of PANI-DNNSA (41 wt %) into a glass vial and to it was added varying amounts of each agent. The resulting solution was mixed using a vortex stirrer and spin coated onto 2.5 cm 2 glass slides with the following parameters (2000 rpm, 40 secs) before curing in the oven at 150° C. for 30 mins. The resistance of each sample was then measured using the multiplate conductivity reader. The samples were judged to have failed once the resistance went over 100 MS), this became the failure time (h).

TABLE 42
Agent name and abbreviation used in the screening experiments.

| | |
|---|---|
| Omyacarb 1 (~2 μm) - CaCO₃ | O1 |
| Omyacarb 1T (~2 μm) - CaCO₃ | O1T |
| Omyacarb 2 (~2 μm) - CaCO₃ | O2 |
| Omyacarb 2T (~2 μm) - CaCO₃ | O2T |
| Cabosil Fumed Silica TS-720 | TS-720 |
| Aluminum Oxide (15-25 nm) | Al-15-25 |
| Tioxide | TiO₂ |
| ZnO (s) Micronisers nano | ZnO |
| CeO₂ (Cerium Oxide nano 50-80 nm) | CeO₂ |
| Yttrium oxide | Y₂O₃ |
| M400 Ca₂SiO₄ (Calcium Silicate/Wollastonite) | M400 |
| Magnesium aluminate calcined (MgAl₂O₄) | MAC |
| Calcium Borosilicate CW-291 Halox | Halox |
| Mg(OH)₂ Magnesium Oxide Aldrich | MGO |
| MV talk (Imerys) | MVT |
| ZrO₂ T2-34S (Zirconia) | Zirconia |

One particularly effective agent was found to be calcium borosilicate CW-291 (Halox), Micronisers nano zinc oxide and the various calcium carbonates were also effective, and in particular Omyacarb 1. With these agents the failure time was extended up to 95 h (˜4 days) whereas the unmodified PANI was only stable for 4.5 h. Note that unmodified PANI started at a higher resistance of (11.9 MΩ)) whereas 01 (5 wt %) started at 0.3 MS).

### 3. Preparation of Thermally Stabilised Conducting Polymer Coatings

### Silicone Coating Compatibility and Screening

A series of formulations were prepared to test the solubility of PANI-DNNSA with various of the following silicone-based coatings for high temperature applications:
1. RTV silicone dispersion coating (Nusil, R-1009, 1 pack system)
2. Low viscosity, thermally conductive silicone (Nusil, R-2939, 2 pack system, 1:1 ratio)
3. RFI and EMI shielding RTV silicone elastomer (Nusil, R-2631, 2 pack system, 15:1 ratio)
4. Ice phobic coating (Nusil, R-2180)

Test formulations were prepared using each silicone according to the following general procedures. For R-2631 equal amounts of Part A (5 g) and Part B (5 g) was weighed into a glass jar and thoroughly mixed together. Toluene was then gradually added to check solubility, however if the mixture remained thick and viscous was therefore was not used for spin coating. R-2939 was thoroughly mixed in the ratio of 15:1 Part A (3 g) to Part B (0.2 g) before adding PANI-DNNSA. This resulted in some phase separation. Formulations containing silicone coating (R-2180) resulted in short failure times and generally high initial film resistance. The suggested curing schedule for R-2180 is 30 min at room temperature then 45 min at 75° C. and finally 135 min at 150° C. It was found that this curing schedule was too harsh for PANI without any thermal stabilisers. As such a modified curing schedule was used heating for 1 h at 75° C. then 17 h at 50° C. and finally 30 min at 150° C. Samples were placed in the oven after equilibrating for 5 h at room temperature. Initial film resistance was high and as a result the failure times tended to be short (˜5 h) without any additional stabilizers. Although this silicone formulation preferred lower loading amounts, it can still be useful where mechanical properties require more silicone relative to PANI. The compatibility of PANI and silicone R-1009 was then tested at silicone concentrations from 1-15 wt %. Samples up to 10 wt % formed homogeneous solutions while the 15 wt % sample showed some phase separation. The PANI-silicone samples were then placed in the oven at 150° C. and the conductivity monitored over time. The multiplate conductivity logger can read a maximum resistance of ˜100 M. This was chosen as the failure point for the films and was confirmed using an offline multi-meter. See FIG. 12 regarding samples S1 to S5 providing continuous logging of film resistance for samples containing different amounts of silicone dispersion (R-1009).

There was very little difference in failure time between the different silicone loadings. Based on this result a loading of 10 wt % was selected in order to maximize the amount of silicone on the formulation while avoiding some phase separation seen at higher loadings.

While CaCO₃ and ZnO have been shown the be effective thermal stability agents to reduce PANI thermal decomposition oxidation of the polymer backbone remains. In order to address this process a series of experiments were carried out examining antioxidants. These agents were generally considered to be primary or secondary depending on their mode of action. Primary antioxidants such as hindered phenols (e.g. Irganox 1010 and Irganox 1076) may act as radical scavengers to remove peroxy radicals. Ultimately, primary antioxidants are sacrificial and once they are fully consumed the polymer will begin to degrade. Secondary antioxidants work by removing organic hyperoxides that are formed by the action of primary antioxidants. These can be phosphites but thioethers can be used and can be effective in preventing long term thermal aging. Several formulations were prepared from PANI-DNNSA (4.0 g), R-1009 (10 wt %) and O2 (5 wt %) along with antioxidants as described in Table 5 below. The resulting solutions were stirred for 5 days before spin coating onto glass slides and curing at 60° C. and 70% RH. The films were green, transparent and glossy with no noticeable particles. The samples were considered to have failed once the resistance went over 100 MS), this became the failure time (h).

TABLE 5
PANI formulations containing alkali agents along with antioxidants.
Concentration (C, wt %) refers to component concentration in solution
while Dry (wt %) refers to the concentration in the cured film.

| | | | | | Irg. | Irg. | | |
|---|---|---|---|---|---|---|---|---|
| | PANI | | R-1009 | O2 | 1010 | 1076 | | |
| | Dry | C | Dry | C | C | C | Failure | Devi- |
| Lab | (wt | (wt | (wt | (wt | (wt | (wt | Time | ation |
| Code | %) | %) | %) | %) | %) | %) | (h) | (h) |
| 211a | 34.5 | 84 | 5 | 5 | 0.5 | 0.5 | 103 | 2.6 |
| 211b | 34.1 | 83.1 | 5 | 5 | 1 | 1 | 103 | 2.4 |
| 211c | 34.5 | 84 | 10 | 5 | 0.5 | 0.5 | 91 | 13.4 |
| 211d | 34.1 | 83.1 | 10 | 5 | 1 | 1 | 99 | 0.1 |

All samples with Irganox were significantly better performing than samples without (5 wt % O2 no Irganox=55.6 h). With Irganox samples lasted up to 103 h. Samples A and B performed better than C and D suggesting that 5 wt % silicone in the dry film is better than 10 wt % silicone in the dry film. There did not appear to be any significant difference between 0.5 wt % and 1.0 wt % Irganox loadings.

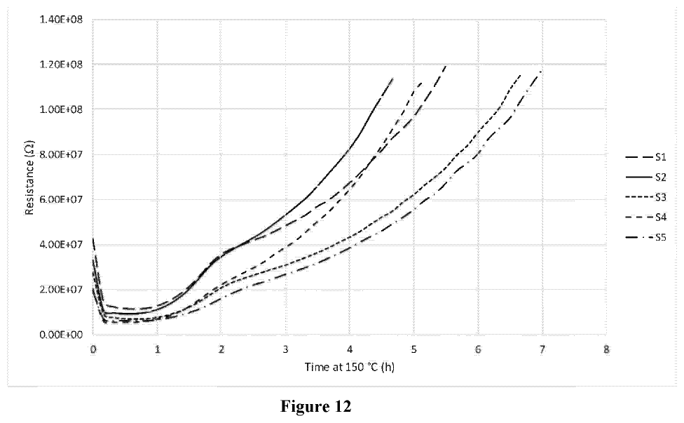

A series of different ZnO concentrations were also explored in PANI-DNNSA formulations. Samples were prepared from PANI-DNNSA (35 wt %). Samples with ZnO loadings of 0, 0.1, 0.5, 1, 2 and 5 wt % gave increasing thermal stability particularly once the loading was above 2 wt % (FIG. 11). Samples with PANI only gave a failure time of 10.8 h. This increased to 12.8 h upon addition of 10 wt % silicone (R-1009). Increasing amounts of ZnO then gave significantly higher thermal stability, extending the failure time to 96.7 h with a 5 wt % loading. When using ZnO it was found that the two different Irganox agents performed differently. Irganox 1010 gave higher performance than Irganox 1076 and significantly higher performance than ZnO alone as shown in the following results:
ZnO 1 wt %=28.2 h failure time
ZnO 1 wt %+Irganox 1076 1 wt %=67.2 h failure time
ZnO 1 wt %+Irganox 1010 1 wt %=79.2 h failure time

O1 (5 wt %) gave a small improvement in failure time over no agent addition (failure time=20.5 h). Combining O1 with Irganox 1076 gave good performance (failure time=92.5 h) while Irganox 1010 only gave 67.0 h.

The descriptions of the various aspects of the present disclosure have been presented for purposes of illustration, but are not intended to be exhaustive or limited to the aspects disclosed. Many modifications and variations will be apparent to those of ordinary skill in the art without departing from the scope of the described aspects. The terminology used herein was chosen to, for example, best explain the principles of the aspects, the practical application or technical improvement over technologies found in the marketplace, or to enable others of ordinary skill in the art to understand the aspects disclosed herein.

1. A liquid formulation comprising:
a solution processable polyaniline conducting polymer in an organic solvent,
one or more first thermal stability agents selected from an alkali metal salt, and optionally an amphoteric metal oxide, and
one or more of second thermal stability agents selected from an antioxidant,
wherein the combined amount of the one or more first thermal stability agents (as a weight % of total formulation) is about 2 wt % to about 7 wt %,
wherein the total amount of the first and second thermal stability agents (as a weight % of total formulation) is less than about 9 wt %,
wherein the first and second thermal stability agents are present in the organic solvent, and
wherein the polyaniline conducting polymer solution has greater than 95% of a polyaniline salt dissolved in the organic solvent.

2. The formulation according to claim 1, wherein the formulation further comprises one or more film formers.

3. A liquid formulation consisting of:
a solution processable polyaniline conducting polymer in an organic solvent,
one or more first thermal stability agents selected from an alkali metal salt, and optionally an amphoteric metal oxide,
one or more second thermal stability agents selected from an antioxidant, and
one or more film formers,
wherein the combined amount of the one or more first thermal stability agents (as a weight % of total formulation) is about 2 wt % to about 7 wt %,
wherein the total amount of the first and second thermal stability agent (as a weight % of total formulation) is less than about 9 wt %,
wherein the first and second thermal stability agents are present in the organic solvent, and
wherein the polyaniline conducting polymer solution has greater than 95% of a polyaniline salt dissolved in the organic solvent.

4. The formulation according to any one of claims 1 to 3, wherein the alkali metal salt comprises a metal selected from one or more of lithium (Li), sodium (Na), potassium (K), beryllium (Be), magnesium (Mg), calcium (Ca), and strontium (Sr), and a counter ion for the metal selected from one or more of hydroxide, carbonate, stearate, borosilicate, bicarbonate, metasilicate, phosphate, and hydrogen phosphate.

5. The formulation according to claim 4, wherein the counter ion for the metal of the alkali metal salt is selected from carbonate, bicarbonate, phosphate, and hydrogen phosphate.

6. The formulation according to claim 4 or claim 5, wherein the metal of the alkali metal salt is calcium (Ca).

7. The formulation according to any one of claims 1 to 6, wherein the alkali metal has an average particle size of less than about 2 μm.

8. The formulation according to any one of claims 1 to 7, wherein the amphoteric metal oxide is an oxide of zinc, zirconium, titanium, magnesium, yttrium, aluminium, or silicon.

9. The formulation according to any one of claims 1 to 8, wherein the amphoteric metal oxide is an oxide of zinc.

10. The formulation according to any one of claims 1 to 9, wherein the amphoteric metal oxide is surface treated, optionally with a polymeric dispersant.

11. The formulation according to any one of claims 1 to 10, wherein the combined amount of the one or more first thermal stability agents (as a weight % of total formulation) is about 5 wt %.

12. The formulation according to any one of claims 1 to 11, wherein the amount of amphoteric metal oxide (as a weight % of total formulation), when present in the formulation, is less than about 3 wt %.

13. The formulation according to any one of claims 1 to 12, wherein the combined amount of the one or more second thermal stability agents (as a weight % of total formulation) is between about 0.5 wt % and about 3 wt %.

14. The formulation according to any one of claims 1 to 13, wherein the combined amount of the one or more second thermal stability agents (as a weight % of total formulation) is about 1 wt %.

15. The formulation according to any one of claims 1 to 15, wherein the antioxidant is selected from one or more hindered phenols.

16. The formulation according to any one of claims 1 to 15, wherein one or more antioxidants are selected from pentaerythritol tetrakis(3-(3,5-di-tert-butyl-4-hydroxyphenyl)propionate), n-octadecyl (3-[3,5-di-tert-butyl-4-hydroxyphenyl]propionate), ethylene bis (oxyethylene) bis-(3-(5-tert-butyl-4-hydroxy-m-tolyl)-propionate), or any combinations thereof.

17. The formulation according to any one of claims 1 to 15, wherein one or more antioxidants are selected from bis(2,4-dicumylphenyl) pentaerythritol diphosphate, distearyl pentaerythritol diphosphite, didodecyl 3,3′-thiodipropionate, tris(2,4-ditert-butylphenyl) phosphite, and combinations thereof.

18. The formulation according to any one of claims 1 to 17, wherein the polyaniline conducting polymer is an organic solvent soluble polyaniline conducting polymer salt made in-situ by polymerising an aniline monomer with a protonic acid.

19. The formulation according to any one of claims 1 to 18, wherein the polyaniline conducting polymer is a polyaniline sulfonate salt.

20. The formulation according to any one of claims 1 to 19, wherein the polyaniline conducting polymer is selected from the group consisting of: polyaniline methanesulfonic acid, polyaniline camphorsulfonic acid, polyaniline p-toluenesufonic acid, polyaniline dodecyl benzene sulfonic acid, polyaniline dinonylnapthalenesulfonate, and combinations thereof.

21. The formulation according to any one of claims 1 to 20, wherein the polyaniline conducting polymer is a polyaniline dinonylnapthalenesulfonate salt.

22. The formulation according to any one of claims 1 to 21, wherein the formulation is a dry film coating.

23. The formulation according to any one of claims 1 to 22, wherein the amount of the polyaniline conducting polymer (as a weight % of total formulation) is between about 80 wt % to about 90 wt %.

24. The formulation according to any one of claims 1 to 23, wherein the amount of the polyaniline conducting polymer (as a weight % of total formulation) is between about 80 wt % to about 85 wt %.

25. The formulation according to any one of claims 1 to 24, wherein the amount of the polyaniline conducting polymer (as a weight % in the organic solvent) is between about 30 wt % to about 40 wt %.

26. The formulation according to any one of claims 1 to 25, wherein the amount of the polyaniline conducting polymer (as weight % in the organic solvent) is about 35 wt %.

27. The formulation according to any one of claims 1 to 26, wherein the first and second thermal stability agent is provided in a particle size of less than about 5 μm.

28. The formulation according to any one of claims 1 to 27, wherein the polyaniline conducting polymer is dissolved in the organic solvent.

29. The formulation according to any one of claims 1 to 28, wherein the organic solvent is selected from aromatic organic solvents.

30. The formulation according to any one of claims 1 to 29, wherein the organic solvent is toluene.

31. The formulation according to any one of claims 1 to 30, wherein the organic solvent is present in an amount (as a weight % of total formulation) of between about to about 99, about 50 to about 90, or about 35 to about 60.

32. The formulation according to any one of claims 1 to 33, wherein any one or more of the first and second thermal stability agents present in the liquid formulation is provided as a suspension or a solid to the liquid formulation.

33. The formulation according to any one of claims 2 to 32, wherein the amount (by weight % of total formulation) of film former that is present in the formulation is between about 5 wt % to about 15 wt %.

34. The formulation according to any one of claims 2 to 33, wherein the amount (by weight % of total formulation) of film former that is present in the formulation is about 10 wt %.

35. The formulation according to claim 33 or claim 34, wherein the film former is selected from one or more of a silicone or polysiloxane.

36. The formulation according to any one of claims 1 to 35, wherein the formulation is used to form a conductive coating that is at least 5 times more conductive than a coating formed using a formulation consisting of a polyaniline conducting polymer salt in organic solvent.

37. The formulation according to any one of claims 1 to 36, in the form of a coating having a resistance of less than about 100 MΩ, about 50 MΩ, about 10 MΩ, or about 5 MΩ.

38. The formulation according to any one of claims 1 to 37, wherein the formulation further comprises one or more dispersants.

39. The formulation according to any one of claims 1 to 38, wherein the formulation is stable at temperatures of about 100° C., about 150° C., about 200° C., about 250° C., or about 300° C.

40. A process for preparing a liquid formulation, comprising the steps of:
mixing (i) one or more first thermal stability agents selected from an alkali metal salt, and optionally an amphoteric metal oxide and (ii) one or more second thermal stability agents selected for an antioxidant with (iii) a polyaniline conducting polymer that is dissolved in an organic solvent, to form the liquid formulation,
wherein the polyaniline conducting polymer is an organic solvent soluble polyaniline conducting polymer salt made in-situ by polymerising an aniline monomer with a protonic acid in the organic solvent,
wherein the combined amount of the one or more first thermal stability agents (as a weight % of total formulation) is about 2 wt % to about 7 wt %,
wherein the total amount of the first and second thermal stability agent (as a weight % of total formulation) is less than about 9 wt %, and
wherein the polyaniline conducting polymer solution has greater than 95% of a polyaniline salt dissolved in the organic solvent.

41. The process of claim 40, further comprising (iv) mixing one or more film formers into the liquid formulation.

42. The process of claim 40 or claim 41, wherein the polyaniline conducting polymer that is dissolved in an organic solvent is passed through a filter of less than about 1 μm pore size prior to addition of the thermal stability agent.

43. The process of any one of claims 40 to 42, wherein the polyaniline conducting polymer that is dissolved in an organic solvent is passed through a filter of between about 0.005 μm to about 1 μm pore size prior to addition of the thermal stability agent.

44. A substrate comprising one or more coating layers, wherein at least one of the coating layers comprises a formulation as defined by any one of claims 1 to 439.

45. A coating applied to an optionally coated substrate, wherein the coating comprises: a polyaniline conducting polymer, one or more first thermal stability agents selected from an alkali metal salt, and optionally an amphoteric metal oxide, and one or more of second thermal stability agents selected from an antioxidant,
wherein the combined amount of the one or more first thermal stability agents (as a weight % of solid film) is about 4 wt % to about 15 wt %, and
wherein the total amount of the first and second thermal stability agents (as a weight % of solid film) is less than about 20 wt %.

46. The coating according to claim 45, wherein the coating is an antistatic coating.

47. The coating according to claim 45 or claim 46, comprising a polysiloxane.

48. The coating according to any one of claims 45 to 47, wherein the coating has a thickness in a range of about 1 to about 10 μm.

49. The coating according to any one of claims 45 to 48, wherein the coating is at least 5 times more conductive than a coating formed using a formulation consisting of a polyaniline conducting polymer in organic solvent.

50. A coating system comprising:
(i) an optionally coated substrate;
(ii) one or more optional post coating layers; and
(iii) one or more layers located between (i) and (ii) comprising a formulation as defined in any one of claims 1 to 39, or the coating as defined in any one of claims 45 to 47.

51. The coating system according to claim 50, wherein the coating system is an antistatic coating.

52. The coating according to claim 50 or claim 51, comprising a polysiloxane.

53. The coating of any one of claims 45 to 49, or the coating system according to any one of claims 50 to 52, wherein the substrate is selected from a metal, metal alloy, polymer, composite, carbon fibre, glass fibre, or silicon based material.
